(19) United States
(12) Patent Application Publication
(10) Pub. No.: US 2020/0202670 A1
(43) Pub. Date: Jun. 25, 2020

(54) GAMING SYSTEM AND METHOD INCLUDING A PROGRESSIVE NON-MONETARY AWARD

(71) Applicant: ADP GAUSELMANN GMBH, Espelkamp (DE)

(72) Inventors: Charles Hiten, Lighthouse, FL (US); Michael Charles Halvorson, Las Vegas, NV (US)

(21) Appl. No.: 16/230,843

(22) Filed: Dec. 21, 2018

(51) Int. Cl. G07F 17/32; G07F 17/34

(52) U.S. Cl. CPC G07F 17/3258; G07F 17/3216; G07F 17/34; G07F 17/3248

(57) ABSTRACT

Various embodiments of a gaming system and method are disclosed as having progressive non-monetary awards. In some embodiments, a non-monetary award is a play of a game having one or more active special game features but does not directly result in a player winning cash, credits, or items that can be converted directly to cash. The gaming system may accumulate a progressive non-monetary award from one or more portions of players' wagers over plays of a game on the gaming system, wherein the progressive non-monetary award may include a plurality of non-monetary awards. The gaming system may calculate non-monetary award contributions to the progressive non-monetary award based on a face value of a play of the game and a theoretical return to player percentage associated with the game.

### FIELD

The present disclosure relates to gaming devices.

### BACKGROUND

Gaming systems that accept wagers in exchange for the opportunity to win awards are known. Progressive monetary jackpot systems have been employed in the gaming industry. A progressive monetary jackpot involves contributing a portion of a wager to the monetary jackpot during each play of a game in which the monetary jackpot is not awarded. Based on a jackpot winning event during one play of the game, the gaming system provides the monetary jackpot award to the player. The player obtains money from the monetary jackpot or credits that can be directly exchanged for money. Gaming systems that offer new ways to win different awards are needed to gain and retain players' interest in the gaming systems.

### SUMMARY

Various embodiments of a gaming system and method are disclosed as having progressive non-monetary awards. In some embodiments, a progressive non-monetary award comprises features of games but does not directly result in a player winning cash, credits, or items that can be converted to cash.

In some embodiments, the progressive non-monetary award relates to quantities of games that a player can play on the gaming system after winning the progressive non-monetary award. In some embodiments, the progressive non-monetary award comprises one or more plays of a game where special game features are activated. In some embodiments, the special game features may include, but are not limited to, award multipliers and generated symbols that are held between plays of the game. In some embodiments where special game features are active (e.g., associated with plays of a game based on obtaining a non-monetary progressive award), a play of the game may require a wager. Thus, it should be appreciated that progressive non-monetary awards can be quantities of games with active special game features in some embodiments. It should further be appreciated that awarded quantities of games having special game features has the potential to provide monetary awards to the player in accordance with, in some embodiments, one or more pay tables of the gaming system. In some embodiments, the special game features are activated during quantities of games awarded by triggering the non-monetary progressive award, but the special game features may be unavailable during other plays of the game. Further, it should be appreciated that, in some embodiments, more than one progressive non-monetary award (e.g., special game features) may be active on the gaming system simultaneously. In some embodiments, the gaming system accepts wagers before executing the one or more quantities of games based on the non-monetary progressive award.

In some embodiments the gaming system may track accumulated quantities of games available for the progressive non-monetary award through a progressive non-monetary award counter. The progressive non-monetary award counter may correlate to the accumulated quantities of games having special game features available for a player to win in some embodiments. The progressive non-monetary award counter may be displayed to the player and show a number or quantity of progressive non-monetary awards that are available to win.

In some embodiments, the gaming system accumulates a progressive non-monetary award from one or more portions of players' wagers over plays of a game at the gaming system. The gaming system calculates non-monetary award contributions based on a prize value of a non-monetary award. In some embodiments, the prize value of each non-monetary award equals the face value of a play of the game multiplied by the theoretical return to player percentage associated with the game. In some embodiments, based on the calculated prize value of the non-monetary award, the gaming system may accumulate portions of each wager to form a non-monetary award contribution. Depending on a player's wager, the non-monetary award contribution may be expressed in one or more whole units of a non-monetary award or as fractions of a unit of a non-monetary award. The gaming system accumulates the non-monetary award contributions over time (via one or more plays of the game). In some embodiments, the gaming system may accumulate the progressive non-monetary award until the gaming system generates a triggering condition associated with issuing the progressive non-monetary award during a play of the game. When the triggering condition is generated, the gaming system issues the progressive non-monetary award to the player. The gaming system may begin executing games associated with the progressive non-monetary award or the gaming system may allow the player to store the progressive non-monetary award for later plays of the game. In some embodiments, the gaming system funds a progressive non-monetary award based on a player's time on the gaming system. For example, in some embodiments, the gaming system may increase the progressive non-monetary award when a player continues to play games at a gaming system after one or more determined periodic time thresholds. For example, in some embodiments, a gaming system may increase a progressive non-monetary award when the player continues to play at a particular gaming system for a predetermined period of time (e.g., 20 minutes or some other suitable period of time). In some embodiments, the gaming system may increase the progressive non-monetary award for one or more predetermined periods of time that the player remains playing games at a particular gaming system.

In some embodiments, the gaming system may accumulate one or more progressive non-monetary award seeds. Like the progressive non-monetary award, the gaming system may also accumulate a portion of a player's wager over plays of a game to form a progressive non-monetary award seed. In some embodiments, the portions of wagers may be accumulated until the progressive non-monetary award seed includes a predetermined quantity of non-monetary awards. In some embodiments, the gaming system uses the progressive non-monetary award seed to replenish the progressive non-monetary award after a progressive non-monetary award is provided to a player (e.g., to avoid the progressive non-monetary award starting at zero).

By enabling the player to build progressive non-monetary awards and obtain non-monetary award payouts, the gaming system offers players new ways to obtain game awards and enhances players' excitement for a game. Moreover, by providing a progressive non-monetary award comprising quantities of games with an active special game feature otherwise unavailable to a player, the gaming system offers players even greater new ways to obtain game awards that are not monetary awards. Non-monetary awards may provide players with additional opportunities to win monetary awards. This new potential to earn non-monetary awards including, in some embodiments, quantities of games where a special feature is active, creates a greatly improved sense of anticipation for players of gaming systems having progressive non-monetary awards for players.

### BRIEF DESCRIPTION OF THE DRAWINGS

FIG. 1 is a perspective view of one embodiment of a stand-alone gaming device of a gaming system.

FIG. 2 is a functional block diagram of the gaming device technology components of the gaming system.

FIGS. 3A, 3B, 3C, and 3D illustrate one embodiment of a method of operating the gaming system including a progressive non-monetary award.

FIG. 4 illustrates one embodiment of a pay table with a progressive non-monetary award.

FIG. 5 illustrates a plurality of standalone gaming systems including a progressive non- monetary award.

FIG. 6 illustrates a plurality of linked gaming systems including a progressive non-monetary award.

### DETAILED DESCRIPTION

Various embodiments of a gaming system and method are disclosed as including a progressive non-monetary award. In some embodiments, a progressive non-monetary award comprises special game features that can be activated or otherwise made available for a quantity of games but does not directly result in a player winning cash, credits, or items that can be converted to cash. In some embodiments, portions of wagers may be progressively accumulated and converted to form the progressive non-monetary award.

In some embodiments, the progressive non-monetary award relates to quantities of games that a player can play on the gaming system after winning the progressive non-monetary award. In some embodiments, the progressive non-monetary award comprises one or more plays of a game where special game features are activated. In some embodiments, the special game features may include, but are not limited to, award multipliers, wild symbols, and generated symbols that are held between plays of the game. In some embodiments, the gaming system can make the special game features active during quantities of games based on triggering the non-monetary progressive award. In some embodiments, the gaming system accepts wagers before executing the one or more quantities of games based on the non-monetary progressive award.

In some embodiments, the special game features may be applied to a determined quantity of games. As a nonlimiting example, in one embodiment, the special game feature may be an award multiplier applied to monetary awards achieved during the determined quantity of plays of the game (e.g., after triggering the progressive non-monetary award) on the gaming system. In some embodiments, the award multiplier may be based on a number of available progressive non-monetary awards shown in a progressive non-monetary award counter at the time the progressive non-monetary award is triggered, and the determined quantity of games may be predetermined. In some embodiments, the award multiplier may be predetermined, and the determined quantity of games may be based on the number displayed in the progressive non-monetary award counter at the time the progressive non-monetary award is triggered. In some embodiments, the award multiplier may be randomly selected from a predetermined range, and the determined quantity of games may be based on the number displayed in the progressive non-monetary award counter at the time the progressive non-monetary award is triggered. In one embodiment, both the award multiplier and the determined quantity of games may be based on or equal to the progressive non-monetary award counter at the time the progressive non-monetary award is triggered.

In some embodiments, the special game feature associated with a progressive non-monetary award may be one or more special symbols that can be held during a determined quantity of plays of the game on the gaming system when the gaming system generates and displays the special symbols. The one or more special symbols that can be held can be randomly determined or predetermined in some embodiments. In some embodiments, when the special game feature is one or more special symbols, the determined quantity of plays of the game may be determined as previously discussed.

In some embodiments, the gaming system builds a progressive non-monetary award from one or more portions of players' wagers over plays of a game at the gaming system. The gaming system calculates non-monetary award contributions based on a prize value of a non-monetary award. In some embodiments, the prize value of a non-monetary award equals the face value of a play of the game multiplied by the theoretical return to player value associated with the game. In some embodiments, based on the calculated prize value of a non-monetary award, the gaming system may accumulate portions of each wager and convert the accumulated portions into a non-monetary award contribution. Depending on a player's wager, the non-monetary award contribution may be expressed in one or more whole units of the non-monetary award or as fractions of a unit of the non-monetary award. The gaming system accumulates the non-monetary award contributions over time (via one or more plays of the game), by accumulating the non-monetary award contributions to form the progressive non-monetary award. In some embodiments, the gaming system may accumulate the non-monetary award contributions until the gaming system generates a triggering condition associated with the progressive non-monetary award during a play of the game. When the triggering condition is generated, the gaming system issues the progressive non-monetary award to the player. The gaming system may begin executing games associated with the progressive non-monetary award or allow the player to store the progressive non-monetary award for later plays of the game.

In one embodiment, the gaming system may accumulate a portion of one or more received wagers to build the progressive non-monetary award. The gaming system may convert the accumulated portions of the wagers to a non-monetary award contribution of a progressive non-monetary award. In one embodiment, the gaming system may convert the accumulated portions of the wagers to a non-monetary award contribution based on a prize value of a non-monetary award and a theoretical return to player percentage associated with the game.

In embodiments where the progressive non-monetary award relates to quantities of games (e.g., quantities of games with active special game features), the gaming system may track accumulated quantities of games available for the progressive non-monetary award through a progressive non-monetary award counter. The progressive non-monetary award counter correlates to the accumulated quantities of award games available for a player to win in some embodiments. In some embodiments, the progressive non-monetary award counter may be displayed to the player and show a number or quantity of progressive non-monetary awards that are available to win.

In some embodiments, the gaming system may increase the progressive non-monetary award until the gaming system generates a triggering condition associated with issuing the progressive non-monetary award during a play of the game. When the triggering condition is generated, the gaming system issues the progressive non-monetary award to the player by transferring the number associated with the progressive non-monetary award counter to a non-monetary player award counter and resets the progressive non-monetary award counter (e.g., the progressive non-monetary award counter may display zero or a number associated with a seed). In some embodiments, the gaming system may begin executing games associated with the progressive non-monetary award upon issuance of the progressive non-monetary award. In some embodiments, the gaming system may allow the player to store the progressive non-monetary award for later plays of the gaming system.

In some embodiments, the gaming system tracks the player's use of the progressive non-monetary award via a non-monetary player award counter. In some embodiments, the non-monetary player award counter correlates to the quantity of remaining award games available for the player to play (also sometimes referred to herein as games with an active progressive non-monetary award). It should be appreciated that the non-monetary player award counter is not used in embodiments where the progressive non-monetary award does not include awards related to quantities of games.

In one embodiment, the gaming system may implement the progressive non-monetary award via counters. It should be appreciated that the gaming system may implement the progressive non-monetary awards as described herein without the need for additional or separate monetary meters or a dedicated or centralized controller (e.g., a monetary controller, a progressive controller, a central controller). That is, in some embodiments, a distributed or decentralized systems is used for tracking and awarding the progressive non-monetary award.

In some embodiments, the gaming system may also accumulate one or more progressive non-monetary award seeds. Like the progressive non-monetary award, the gaming system may also accumulate a portion of a player's wager over plays of a game to form a progressive non-monetary award seed. In some embodiments, the portions of wagers may be accumulated until the progressive non-monetary award seed includes a predetermined quantity of non-monetary awards. In some embodiments, the gaming system uses the progressive non-monetary award seed to replenish the progressive non-monetary award after a progressive non-monetary award is awarded to a player (e.g., to avoid the progressive non-monetary award starting at zero).

In some embodiments, a gaming system and method having a progressive non-monetary award may be implemented on a stand-alone gaming system. In one embodiment, the gaming system accumulates a portion of wagers placed on the gaming system and converts the accumulated portions of the wagers into non-monetary award contributions to form a progressive non-monetary award available to a player of the gaming system. In some embodiments, a gaming system and method having a progressive non-monetary award may be implemented via a plurality of linked gaming systems. In one embodiment, the gaming system accumulates a portion of wagers placed on one or more of the plurality of linked gaming systems and converts the accumulated portions into non-monetary award contributions to form a common progressive non-monetary award available to players on one or more of the plurality of linked gaming systems. In some embodiments, the gaming systems may be linked to rapidly build the progressive non-monetary award and to create larger progressive non-monetary awards for players. Large progressive non-monetary awards greatly enhance player excitement for a game. In some embodiments, a plurality of progressive non-monetary awards may be available where one or more of the progressive non-monetary awards are funded via the stand-alone gaming system and one or more of the progressive non-monetary awards are funded via a plurality of linked gaming systems. In some embodiments with a plurality of progressive non-monetary awards, the gaming system may also include one or more predetermined non-monetary awards that are not progressively funded.

As will be appreciated from the discussion hereinbelow, gaming systems having a progressive non-monetary award may create exciting new game play for players. In some embodiments, the gaming system can quickly build attractive progressive non-monetary awards.

### Gaming Device Platform

The features and advantages of the gaming system and method described herein may be provided to a player via a gaming device platform that includes various structures and components for allowing player interaction with the gaming device. While only one gaming device platform will be described in detail herein, the features, objects, and advantages of the gaming system described herein may be implemented in one or more alternative gaming device platforms.

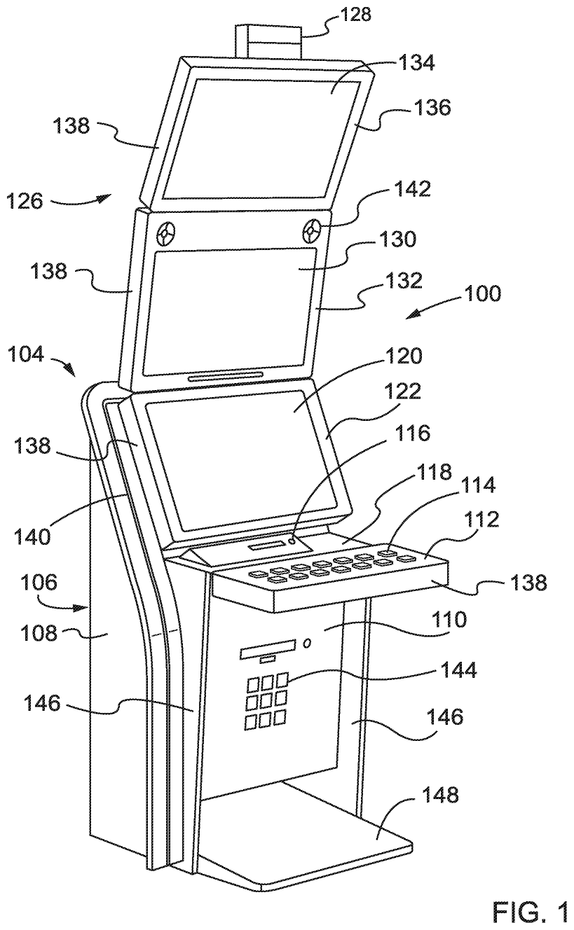

One embodiment of a gaming device platform is shown in FIG. 1 where a gaming device 100 is generally shown. In one embodiment, the gaming device 100 is referred to as a slot machine and is illustrated as housed in a housing or cabinet constructed so that a player can operate and play the gaming device 100 while standing or sitting.

Gaming device 100 may include cabinet 104 for housing the components fully described hereinbelow. The cabinet 104 has a lower cabinet body portion 106 which includes a pair of cabinet side panels 108 (only one of which is viewable in the perspective view of FIG. 1), front panel 110, and a rear panel (not shown). A base panel (not shown) and a top panel surface (not shown) that supports first game display 120 and the player interaction area 112, are provided. The cabinet panels are interconnected along their edges and cooperate to form a cabinet enclosure for housing the gaming device, as can be seen in FIG. 1.

It should be appreciated that a wide variety of cabinet enclosure sizes, shapes, and designs are possible for the gaming device 100. Cabinet 104 may function to securely protect any local control system, technology components, and provide support for game display(s) and player input and output interactions with the gaming device.

Returning to FIG. 1, the gaming device enables the player to interact with the gaming device 100 to direct the wagering and game play activities and preferences. Various forms of player interaction devices and activities will now be described.

Cabinet 104 includes a player interaction area having input and output areas generally designated as 112. The player interaction area 112 may be located on the front top side of cabinet 104 and, as shown, on a panel structure that extends outwardly from the gaming device in a player's direction. Player interaction area 112 may contain a plurality of player input and output structures such as player control button area 114, player value acceptor and dispenser area 116, and player convenience input area 118.

Player control button area 114 includes a plurality of buttons, touch sensitive areas, or both through with which players may interact with the one or more processors of gaming device 100 and direct game play. It is expected that cabinet 104 provides an easily accessible location and support for all necessary player input/output (I/O) interactions with the device, including gaming control interactions and value wagering interactions. Although the gaming device 100 illustrated in FIG. 1 shows player controls provided by buttons of player control button area 114, it is understood that in one embodiment, a player's gaming control interactions could be made by either buttons mounted on cabinet 104 or “soft” buttons located on the gaming display and activated by player touch (e.g., touch screen interfaces), or a combination of both arrangements.

Player control button area 114 may include, for example: game selection button(s) in any embodiments where more than one game is provided in a single gaming device; gaming denomination value selection button(s) in any embodiments where one or more wagering denomination value is accommodated; wager selection button(s) for the player to indicate or select the desired wager value for a game in any embodiments where a selection of wager values are offered; pay line selection button(s) for selecting the number of active pay lines in game embodiments that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information. As discussed above, the functions of the buttons in player control button area 114 may be duplicated with soft buttons in the player control button area 114 or as soft buttons in other areas of the gaming device 100 (e.g., as a touch screen overlay over available game displays).

Gaming device 100 may include one or more forms of value acceptance and value distribution to allow the player to interact with the device and to risk or otherwise place a wager (a monetary value) on one or more outcomes of a game. Winnings may be returned to the player via some form of value distribution. As illustrated in FIG. 1, player value acceptor and dispenser area 116 is provided. In the player value acceptor and dispenser area 116, a player supplies monetary value to the gaming device 100 via one or more value acceptor devices. In one embodiment, the player value acceptor and dispenser area 116 (through the one or more value acceptor devices) may accept any one or more of the following from a player to establish a gaming credit balance: coins, bills, tokens, tickets/vouchers, player ID cards, credit cards, or other suitable forms of value. Thus, if the gaming device 100 accepts coins and bill, the gaming device 100 includes a currency bill validator and a coin validator as the value acceptor devices. Likewise, if the gaming device 100 accepts tickets, the gaming device includes a ticket acceptor as a value acceptor device for receiving tickets or vouchers representing some monetary value. The ticket acceptor may include a bar code reader, or other appropriate code reader, for reading the encoded value contained by the player's ticket or voucher. In some embodiments, the player value acceptor and dispenser area 116 may include a value acceptor device that can accept more than one type of value. In some embodiments, the player value acceptor and dispenser area 116 may include multiple different value acceptor devices to accept different types of value from players.

Upon receipt of some type of value from the player, a value acceptor device of the player value acceptor and dispenser area 116 performs validation on the player supplied value using appropriate hardware readers (e.g., determining that the currency bills/coins/tokens are genuine, or the ticket/voucher is genuine). If the validation result is positive on player supplied value, the appropriate value acceptor device generates a signal to a processor of the gaming device 100 to establish a gaming credit balance for plays of one or more games on gaming device 100.

In one embodiment, a player receives monetary value, or a representation thereof, from the gaming device 100 when a player chooses to “cash out” the gaming credit balance (e.g., remove value from the gaming device 100). The player can cash out at any suitable time. When a player cashes out the value contained on a credit meter (not shown) of gaming device 100, a processor of gaming device 100 may cause a printer of gaming device 100 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device or converted to currency at a conveniently located kiosk or cashier counter located near the gaming device. Alternatively, the processor of gaming device 100 may cause a currency bill dispenser or a coin dispenser in gaming device 100 to dispense the value contained on the credit meter of gaming device 100.

Various combinations of the above value acceptance and value distribution arrangements are possible. Gaming device 100 may include other value acceptance and value distribution mechanisms in the player value acceptor and dispenser area 116. For example, gaming device 100 may include a magnetic strip or chip card reader/writer in order to accept value from and transfer value to a magnetic strip or an embedded chip card. In other embodiments, hardware for transferring (and receiving) non-traditional currencies to players such as digital currencies (e.g., bitcoin) may be included in gaming device 100.

In an alternative embodiment, gaming device 100 may include a card reader (not illustrated) in the in the player value acceptor and dispenser area 116, which accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming device may be associated with the player account. It is noted that a numeric or alphanumeric keypad may be provided adjacent to the card reader slot to enable player entry of a personal identification number or the like for secure access to card information.

In one embodiment, a player convenience input area 118 may be included in the gaming device 100, as is shown in FIG. 1. In various embodiments, player convenience input area 118 may have a variety of features and functions depending on the jurisdictional deployment of the gaming device 100. In one embodiment, the player convenience input area 118 will house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into a gaming device during play. These player loyalty/player tracking cards are associated with a player account and are utilized by the card-issuing entity to monitor or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain embodiments, the player convenience input area 118 may include player convenience features such as a pocket for storage that allows players to store their personal items such as a mobile phone. Gaming device 100 may include one or more universal serial bus (USB) ports that enables a player to charge their electronics or connect to services such as the Internet or food service. Further, player convenience input area 118 of gaming device 100 may include buttons to request food or drink service if the gaming device is located in an establishment that has food and drink service. The gaming device 100 may be connected to a local or wide area network such that selection of the requested food or drink service will alert the establishment's hospitality staff to deliver the requested service directly to the gaming device 100.

The layout of the player control button area 114, player value acceptor and dispenser area 116 and the player convenience input area 118 in gaming device 100 may be arranged differently than those disclosed and illustrated herein. The selections and arrangement of input locations on the cabinet 104 may be dependent upon the game buttons, the type of value wagered, and the player conveniences utilized in the deployment configuration of gaming device 100.

With continuing reference to FIG. 1, in one embodiment, lower cabinet body portion 106 includes a first game display 120 mounted atop or flush with the lower cabinet body portion's top panel surface. First game display 120 is, for example, a 27-inch liquid crystal display (LCD) display mounted in a widescreen orientation. However, any suitable display may be used in any suitable orientation. In the illustrated embodiment, the first game display 120 is mounted within and framed by first display frame 122 which is, in turn, mounted upon lower cabinet body portion's top panel surface. In this manner, the first game display 120 is both surrounded and secured within the first display frame 122 and raised above the cabinet's top panel surface. Additional features of the first display frame 122 will be described below. In one embodiment, gaming device 100 may use one first game display 120 and not include additional game displays (not illustrated).

The lower cabinet body portion 106 is further constructed to support upper cabinet portion 126. Upper cabinet portion 126 may be comprised of an upwardly extending support structure (not illustrated) that extends upwardly from the rear side of lower cabinet body portion 106 and is sufficiently strong to support one or more additional game displays.

At the topmost end of the support structure, a cabinet top light 128 may be provided. The cabinet top light 128 is capable of illumination in a variety of colors and is utilized to indicate and communicate gaming device conditions to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In one embodiment, as illustrated in FIG. 1, gaming device 100 includes two additional displays, second game display 130 and third game display 134. Second game display 130 and third game display 134 are disposed generally in a vertical relationship and generally in alignment with the first game display 120. Like the first game display 120, second game display 130 and third game display 134 can be 27-inch LCD displays and can be mounted in a widescreen orientation in one embodiment. However, any suitable display in any suitable orientation may be used for the second game display 130 and the third game display 134. Further, like the first game display 120, second game display 130 and third game display 134 can be mounted within and framed by second display frame 132 and third display frame 136, respectively. Second display frame 132 and third display frame 136 are attached to the upper cabinet support structure and can protect the second game display 130 and the third game display 134.

First game display 120, second game display 130, and third game display 134 can be disposed at an angle from each other to form a player-facing concave arc. However, in some embodiments, the angles between the displays may be adjustable and may be smaller or greater than the angles illustrated in FIG. 1. Further, it is understood that in some embodiments the displays may be disposed in a common plane relative to each other.

It also should be appreciated that in various embodiments a variety of display technology may be utilized equivalently and interchangeably with a variety of embodiments of the gaming device. Equivalent display devices include all variations of liquid crystal displays, light emitting diode displays, and plasma displays.

In some embodiments, different sized displays may be combined to display gaming data on gaming device 100. As a non-limiting example, a 27-inch widescreen LCD display may be combined with a 20-inch portrait oriented LCD or a light emitting diode (LED) display. This combination may be used, for example, with a third scrolling banner LED display. In alternative embodiments, one, two, three, or more displays could be used in a variety of positions and orientations. Any suitable combination may be used. It should also be appreciated that a processor of gaming device 100 may communicate with the disclosed first game display 120, second game display 130, and third game display 134 through a video card of gaming device 100 to produce the visible aspects of a game.

In one embodiment, one or more of the first game display 120, second game display 130, and third game display 134 may be fitted with a transparent touch sensitive overlay for sensing player touch inputs into the gaming device. Touch sensitive overlays can communicate with a processor of gaming device 100 to enable the player to interact with the game.

In some embodiments, the curved displays may be used for any or all of the first game display 120, second game display 130, or third game display 134. Similarly, any of the displays used for gaming device 100 can be based on flexible display technologies. For example, it is possible to utilize flexible display technologies to create uniquely shaped curving, wavy, or tubular display structures to provide one or more of the first game display 120, second game display 130, and third game display 134. Additionally, in one embodiment flexible display technologies can be used in combination with fixed flat screen technologies.

While the gaming device 100 has been described as implemented with video technologies, in one embodiment, mechanical reels with reel strips containing game indicia and step motor controllers may be employed to provide game information to a player. In one embodiment, the reel strips may include a plurality of printed symbols. In another embodiment, the mechanical reels may include flexible video display technology as the reel strips on mechanical reels. Thus, games implemented in video form can readily be implemented with mechanical reels utilizing such display technology. Alternatively, in other embodiments mechanical reels with reels strips having fixed symbols displayed along the reel strip could be used to implement the game.

Dependent upon the particular gaming device housing style, a variety of other display technologies may be utilized in combination with the gaming device disclosed herein. For example, in some embodiments a gaming device may have one or more display devices in addition to the main game display(s). For example, the gaming device may include a player tracking device having a player tracking display which displays various information to the player regarding the player's status. The gaming device may also include other game-related displays such as the wager display and the gaming credit balance display. These additional game-related displays may be separate display devices or may be displayed on any one or more of the first game display 120, the second game display 130, or the third game display 134.

Cabinet lighting design functions to attract players to a gaming device 100. In the embodiment of FIG. 1, attractive cabinet lighting is provided by frame accent lighting 138. It is noted that frame accent lighting 138 is a common structure found on each of the first display frame 122, the second display frame 132, and the third display frame 136 and player interaction area 112. Example areas where frame accent lighting is applied to gaming device 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In one embodiment, the circuit boards are flexible circuit boards. These LED strips and transparent or translucent coverings may surround one or more gaming device displays frames, as well as the player interaction area, to highlight these areas.

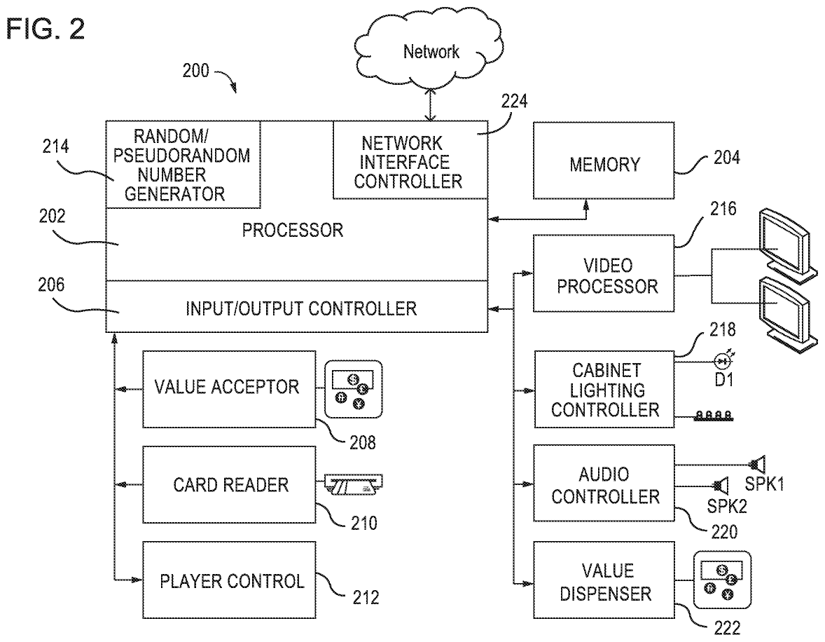

In one embodiment, the individual LEDs mounted on the LED strips are of a type that can emit red, green, and blue light. In an alternative embodiment, separate LEDs are used for each required light color. All LED strips can be electrically connected and can be controlled by a cabinet lighting controller 218 (illustrated in FIG. 2) in conjunction with a processor of gaming device 100 to selectively mix the emitted light colors in a manner to create any color. The cabinet lighting controller 218 can flash and vary lighting as desired. For example, cabinet edge lighting can change and flash in combination with music rhythms or in combination with game events. Other variations are possible.

In some embodiments, cabinet 104 may include LED strip lighting or LED rope lighting to accentuate the cabinet and enhance the attractiveness of gaming device 100 to players. LED rope lighting is a plurality of small light-emitting diode bulbs linked together and encased in a plastic, polyvinylchloride, or other suitable material to create a string of lights. For example, in the embodiment of FIG. 1, cabinet 104 includes cabinet accent lighting 140. In one embodiment, cabinet accent lighting 140 is LED rope lighting mounted flush with the front side edge of the cabinet side panels 108. The LED rope lighting can generate any of suitable colors and are controlled by cabinet lighting controller 218 and a processor of gaming device 100 to selectively mix the emitted light colors in a manner to create any color in the same manner as the frame edge lighting.

In various embodiments, gaming device 100 includes one or more audio speakers and appropriate driving electronics and sound cards so that game players may experience pleasing audio aspects of the gaming device 100. Audio is desirable to attract and maintain player interest in gaming device 100. Gaming device 100 may also emit attraction sounds during any idle period of gaming device 100. Game audio may add to the player's enjoyment of gaming device 100 by providing music and sound effects designed to enhance and compliment the gaming experience.

Audio speaker hardware may include one or more speakers disposed in or on the cabinet 104 of gaming device 100. In FIG. 1, a pair of audio speakers 142 are shown mounted on the upper corners of second display frame 132. Any suitable number of additional speakers may be provided on additional display frames or on the lower cabinet body portion 106 as desired.

Speakers designed for emitting bass vibrations may be included in some embodiments. Speaker placement may be selected to enhance the sound emitting characteristics of the gaming device. For example, bass speakers or additional speakers 144 may be mounted inside lower cabinet body portion 106. Further, it is envisioned that in some embodiments sound processing such as multichannel processing and surround sound processing are included in gaming device 100. Audio jacks for attachment of player headphones may also be provided in some embodiments of gaming device 100 for the player to further enhance the audio experience of the game and also to block out noise from other gaming devices.

In one embodiment, front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing gaming device 100 in a seated position. Foot rest 148, which may be cushioned, is provided below player interaction area 112 to enhance a player's ergonomic comfort while playing gaming device 100. In one embodiment, the edges of player interaction area 112 may be ergonomically cushioned as well.

Gaming device 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary 3) provide an easy location and support for all necessary player input/output (I/O) interactions, including gaming control interactions and value wagering interactions. For example, in some embodiments the gaming device 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In one embodiment, housing styles of cabinet 104 of gaming device 100 may include bar top or table top housing arrangements. These housings are generally small enough to be placed on top of an existing bar or table while providing the requisite gaming device housing functions of protection of/access to gaming electronics, displays, and player I/O functions described above.

In one embodiment, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

Turning now to FIG. 2, the features and advantages of the gaming system described above will now be described in terms of the various technology components for allowing player interaction with the gaming device 100.

FIG. 2 illustrates a functional block diagram of an embodiment of technology components of gaming device 100 that are specially configured to carry out the game function and operations described herein. The functional elements shown in FIG. 2 cooperate, on a broad and general level, to function as gaming device 100. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In one embodiment, gaming device 100 is functionally controlled by control unit 200. Control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one embodiment, control unit is also configured to communicate with a server device through a network.

In one embodiment, control unit 200 includes at least one specially configured processor 202 or central processing unit (CPU). In one embodiment, specially configured processor 202 include arithmetic logic units and math co-processors also known as floating point units. In one embodiment, specially configured processor 202 includes registers for holding instructions or other data, and cache memory for storing data for faster operation thereupon. In one embodiment, specially configured processor 202 may be a multi-core processor that includes two or more processors for enhanced performance, more efficient parallel processing, or other advantageous computing functions. In another embodiment, specially configured processor 202 may be one or more processing devices such as microprocessor(s) or integrated circuit(s) and may include one or more controllers. It should be appreciated that in some embodiments, a general purpose processor could be programmed to perform the functions of specially configured processor 202.

A controller, in one embodiment, is a device or a software program that manages or directs the flow of data between two entities. Often, controllers are special purpose circuitry or software that solve a technical communications problem between different technology systems. In one embodiment, a controller functions as an interface between two systems while managing the communications between the systems. In another embodiment, a controller functions as an interface between a processor and a peripheral device and functions to control the peripheral device.

At least one specially configured processor 202 or controller of control unit 200 is specially configured to communicate with at least one memory device, generally shown as memory device 204 in FIG. 2. In one embodiment, memory device 204 includes one or more memory structures for storing instructions and various types of game data. Memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in one embodiment, communication with a memory device by a processor or a controller encompasses the processor or controller accessing the memory device, exchanging data with the memory device, or storing data to the memory device.

Memory device 204 may store all program code and game code (collectively the “code”), and operation data necessary for the operation of the gaming device 100 and execution of the gaming features described hereinbelow. In an alternative embodiment, game code and operation data necessary for the operation of the gaming device 100 may be store in a distributed manner such that some code is stored in memory device 204 and other code is stored remotely from gaming device 100. In one embodiment, the code and operation data necessary for the operation of the gaming device includes, for example, basic input and output function data, instruction fetching data, bus and network communication protocol data, and like data necessary for an operational gaming device 100. In one embodiment, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in one embodiment, the code and operation data for the operation of the gaming device described above may be stored in removable game cartridges or flash drives, a compact disk ROM, a digital versatile disk (DVD) optical storage technology, or suitable other fixed non-transitory storage mediums. In another embodiment, part or all of the code and operational data for operation of the gaming device or for execution of the game features may be stored in a remote memory structure and be downloaded to the memory device 204 via a network connection.

In one embodiment, the gaming device 100 may utilize any combination of memory devices such as random access memory devices (RAMs), unalterable memory devices (ROMs), and mass storage devices for securely storing and securely communicating the software components or code that facilitate game play and other functions of the gaming device 100. The memory devices may store software components or code that include various game data and game related control and execution software. In some embodiments, the software components stored in the memory devices may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the gaming device 100.

In some embodiments, the memory devices, such as memory device 204, with the software components and other data may be secured and authenticated by authentication software stored in an unalterable memory device within the housing of gaming device 100. The gaming device 100 may also include application specific integrated circuits (ASICs) to perform the security and authentication functions. At any appropriate time, such as before each play of a game, at a predetermined interval, upon transfer of any game data or any software components from a mass storage to memory device 204, or upon demand, the gaming device 100 (using a processor such as processor 202 or a separate ASIC) may execute an authentication routine and perform an authentication of any software component or other data of the gaming device 100. In one embodiment, the gaming device software components may be prepared for authentication via creation and storage of an encrypted signature unique to one or more of the software components.

In one embodiment, an encrypted signature may be created by utilizing a hash function on a software component or code to form a message digest (i.e., a hash of the software component) followed by a key encryption of the message digest to form an encrypted signature unique to the software component. In some embodiments, the key encryption may be public key encryption, private key encryption, or any suitable key encryption schema. The encrypted signature may be stored with the gaming device software component, for example, in a mass storage device or an unalterable memory. During a software component authentication, the gaming device 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and gaming device 100 may allow game play to proceed. However, when the message digests do not match, the gaming device 100 may determine that the software component under authentication may be corrupted or fraudulent and game play may be halted. It should be appreciated that the gaming device 100 may perform other suitable security and authentication checks on the game data or software components. Such authentication and security devices and functions are unique to gaming and casino industry to minimize or prevent fraud in gaming devices and gaming systems.

For a player to interact with gaming device 100, control unit 200 receives and processes player inputs, and control unit 200 causes processed results to be output or communicated to the player. In one embodiment, player inputs are recognized and processed or directed for processing by input/output (I/O) controller 206. Further, I/O controller 206 may process and direct player outputs for communication to the player. I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for each attached input device and output device. In this manner, specially configured processor 202 is freed from the operational details of the peripheral I/O devices. For example, in one embodiment where an input or output device is changed or upgraded, I/O controller 206 can be changed without changing other gaming system 100 components.

In one embodiment, a player deposits value into gaming device 100 by inserting some form of currency into a value acceptor 208 for game play. Alternatively, a player deposits value into gaming device 100 by inserting an encoded paper ticket into a value acceptor 208 for game play in one embodiment. Value acceptor 208 can be combined with a currency reader and validator, and a code reader for reading value encoded on paper tickets. Value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming device 100. During game play, each time a player risks a wager on an outcome, specially configured processor 202 processes the wage and determines the amount of credits to debit from the player's credit balance. When a winning outcome is obtained, specially configured processor 202 is configured to determine the amount of credits to add to the player's credit balance.

As previously mentioned with respect to FIG. 1, a variety of value acceptance arrangements are possible. In one embodiment, the value acceptor 208 could include magnetic strip or chip card readers to accept and transfer value. Value acceptor 208 may also be configured to accept and transfer non-traditional currencies such as digital currencies. In these embodiments, I/O controller 206, a specially configured processor 202, or both contain appropriate control instructions to communicate and extract value from the inserted item containing value. In one embodiment, use of a magnetic strip or embedded chip card, for example a bank card, for value insertion requires specially configured processor 202 to communicate, via network interface controller 224 (described below), with devices external to the gaming device 100.

In one embodiment, card reader 210 may be included in gaming device 100 to accept player loyalty cards. For example, card reader 210 can extract account identifying information from the card and utilizes this information to access the associated account information stored remotely via network interface controller 224. In embodiments where player loyalty/player tracking systems are employed, a player's loyalty account and record of gaming activity can be stored in a networked storage location or database. Specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various embodiments, player control 212 receives a player's game inputs and communicates the player's game inputs to specially configured processor 202. The player's game inputs or requests may include, but are not limited to, wager amounts, pay line selections, game control signals, and cash-out signals. The player control 212 may generate signals based on button presses, touch screen activations, or voice control. The player initiated signals are propagated to the specially configured processor 202 by I/O controller 206. Further, the player initiated signals may direct and inform execution of the game instructions stored in memory device 204 and configured to be executed by specially configured processor 202.

In one embodiment, specially configured processor 202 is configured to execute stored program code and instructions which generate random numbers or pseudo-random numbers. In one embodiment, as illustrated in FIG. 2, a random number generator (RNG) 214 is a software module configured to be executed by specially configured processor 202 for the generation of a true random or pseudo-random number. The code for RNG 214 may be stored in memory device 204. RNG 214 generates random numbers for use by the gaming software during game execution. In one embodiment, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various embodiments, once random symbols are selected based upon the random number generated by RNG 214, patterns of symbols are compared to determine wagering outcomes. In an alternative embodiment, gaming device 100 may include a hardware based random number generator that is in communication with specially configured processor 202 to supply random numbers for game generation purposes. The hardware based random number generator may be incorporated into specially configured processor 202 or can be separate from specially configured processor 202. In some embodiments, the random number generator may be located in a central server or a server that is remote from the gaming device 100. The gaming device 100 may receive the randomly generated values from the central server or remote server.

In yet another embodiment, random generation of “numbers” or symbols may be performed with electro-mechanical components. For example, gaming devices such as gaming device 100 may incorporate a plurality of mechanical reels rotatable about a common axis. A plurality of indicia or symbols may be positioned around the periphery of the plurality of reels. Each of the indicia or symbols on each reel may indicate separate detectable reel stop positions. The reels can be set into a spinning/rotation motion by pulling a lever or pushing a button. In some embodiments, the gaming device 100 can stop the reels by the gaming device 100 actuating, on a random timing basis, a suitable mechanical or electro-mechanical reel brake. When the reels stop rotating, one or more displayed stop positions of each reel is detected. Since the stop positions are each associated with an indicia or symbol, the gaming device can determine whether the combination of stop positions (i.e., translating to a combination of displayed symbols) results in a winning symbol combination.

Returning to FIG. 2, control unit 200 controls the function and output of a plurality of output devices utilized by gaming device 100. In various embodiments, I/O controller 206 serves as an interface unit between specially configured processor 202 and output devices such as video processor 216, cabinet lighting controller 218, audio controller 220, and value dispenser 222.

In one embodiment, video processor 216 communicates with specially configured processor 202 to render all game graphics, video displays, and information on gaming device 100's one or more video display units. In one embodiment, video processor 216 includes one or more processors, controllers, and/or graphics cards for processing the game images, outcomes, and animated displays and coordinating the processed data to be display between, among, or across any or all display devices. In various embodiments, this may include being configured to simulate objects and the movement of objects which represent video reels containing sets of gaming symbols.

It should be appreciated that in certain other embodiments where physical mechanical reels are utilized by the gaming device 100 as a game displays, reel controllers and stepper motors would be provided in lieu of or in addition to video processor 216.

In embodiments which utilize cabinet lighting as described with respect to FIG. 1, a cabinet lighting controller 218 may be utilized to coordinate and control the color and timing of cabinet lighting displays with specially configured processor 202. In certain embodiments which utilize sound design, specially configured processor 202 may utilize audio controller 220 to coordinate and control the sound emissions. In one embodiment, audio controller 220 may include one or more audio processing cards for generating sound and for driving the one, two or more speakers that may be included with gaming device 100.

In various embodiments, players may collect remaining credit value by initiating a request or a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In one embodiment, value dispenser 222 can be controlled to issue the player's credit value using any of the types of value discussed herein. In some embodiments, the player's credit value may be issued to the player via a printed and dispensed encoded paper ticket or token which the player can then exchange at a special purpose kiosk or cashier location for the monetary value encoded into the ticket or token. In some embodiments, the specially configured processor 202 can direct the value dispenser 222 to issue to the player an appropriate amount of coin or bills directly to the player. Additionally, or alternatively, in some embodiments, the player may have the option to electronically direct the credit value to an account associated with the player.

In some embodiments, control unit 200 of gaming device 100 may communicate with one or more devices outside the gaming device 100. For example, gaming device 100 may be connected to a larger gaming network via a local area network (LAN) or a wide area network (WAN). Control unit 200 may communicate with one or more central servers, controllers, or remote devices to execute games, establish credit balances, participate in jackpots, etc. In such embodiments, network communications and connections are accomplished via a network interface controller 224. Network interface controller 224 can be a digital circuit board or card installed in control unit 200 to provide network communications with external devices.

In some embodiments, various additional features and functions are performed by control unit 200. For example, control unit 200 may be specially configured with appropriate software to track all game play events that occur on gaming device 100. In some embodiments, control unit 200 may audit all recorded monetary transactions, including all wager amounts, game outcomes, game winnings, and game payouts that occur through gaming device 100. Further, some embodiments may include security software to assist in protecting the gaming device 100 from tamper or alteration attempts.

### Gaming System Operation

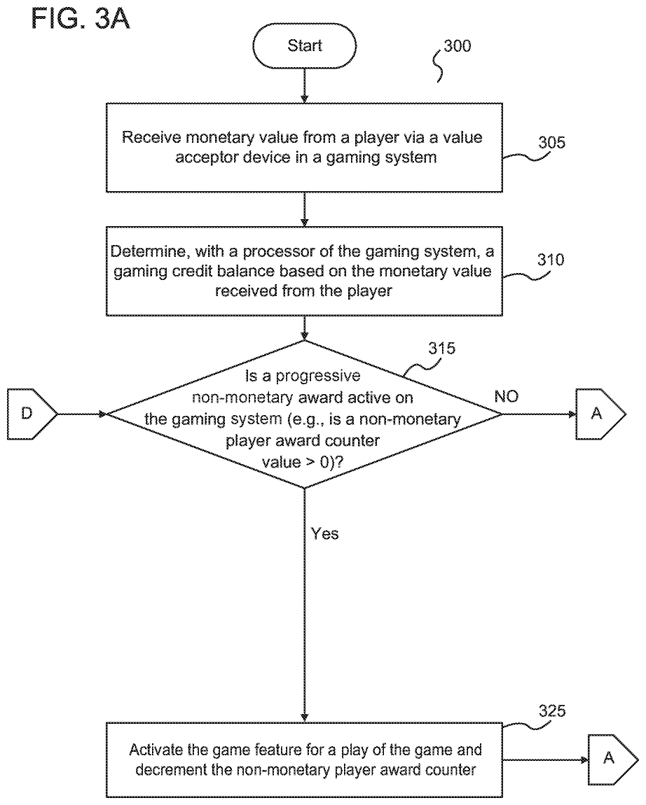

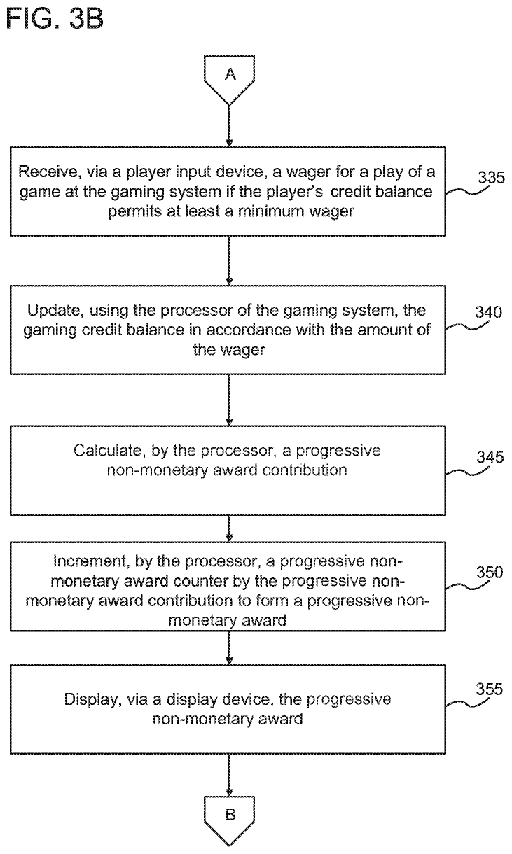

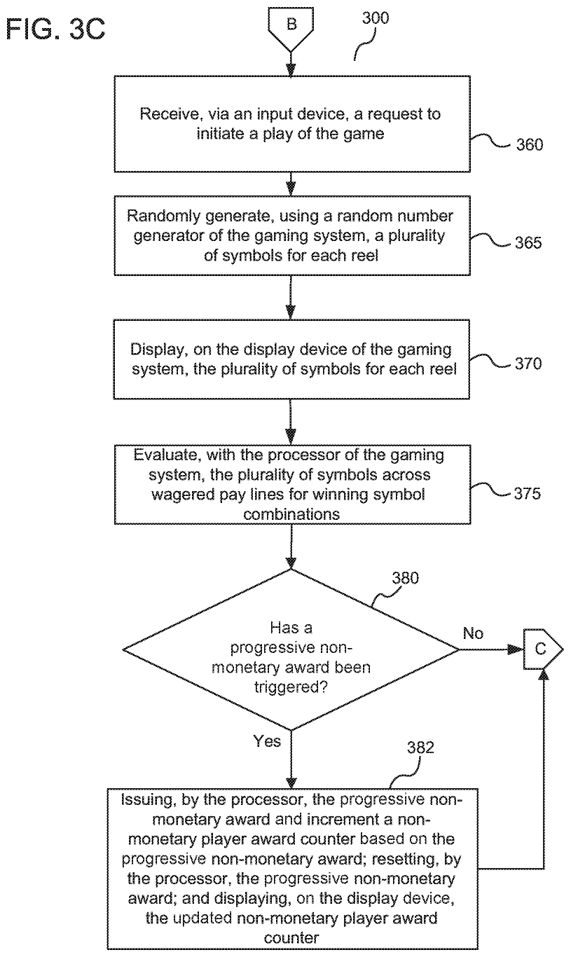

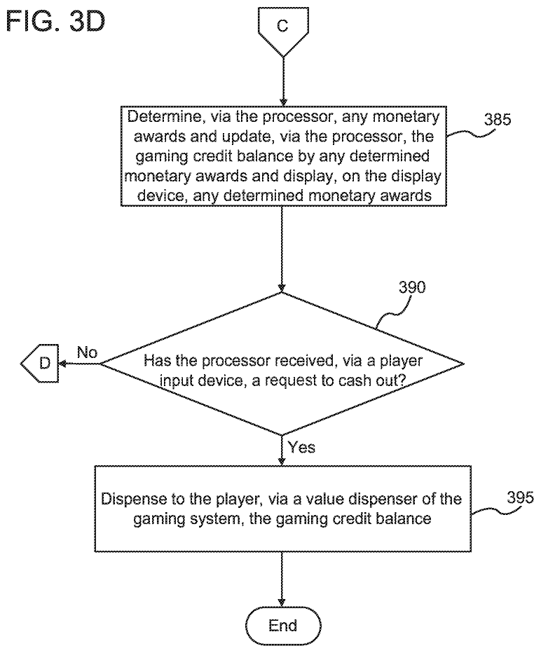

FIGS. 3A, 3B, 3C and 3D illustrate a flowchart of an example operation 300 of one embodiment of the gaming system and method having a progressive non-monetary award. In one embodiment, a processor of the gaming system is configured, via instructions stored in a memory device, to perform the operation 300. However, it should be appreciated that other suitable variations of operation 300 are possible. For example, in one embodiment, fewer or one or more additional blocks (not shown) may be employed in operation 300 of the gaming system and method. In other embodiments, the blocks may be performed in any suitable order.

A play of the game including the gaming system accumulating a progressive non-monetary award will be described in relation to FIGS. 3A-3D first. Thereafter, a play of the game including the gaming system providing the progressive non-monetary award to a player will be described in relation to FIGS. 3A-3D.

In some embodiments, a non-monetary award may comprise games or features of games but does not directly result in a player obtaining cash, credits, or items that can be converted to cash. In some embodiments, the progressive non-monetary award comprises one or more plays of a game where special game features are activated. In some embodiments, the special game features may include, but are not limited to, award multipliers, wild symbols, and generated symbols that are held between plays of the game. In some embodiments where special game features are active, a play of the game may require a wager. Thus, it should be appreciated that progressive non-monetary awards can be quantities of games with special active features in some embodiments. While not discussed herein, the progressive non-monetary award may also comprise non-monetary items other than quantities of games (e.g., quantities of use of game operator facilities such as the pool or Internet, quantities of tickets to shows, etc.).

In embodiments where the progressive non-monetary award relates to quantities of games, the gaming system may track accumulated quantities of games available for the progressive non-monetary award through a progressive non-monetary award counter. The progressive non-monetary award counter may correlate to the accumulated quantities of games available for a player to win.

In some embodiments, when a player wins the progressive non-monetary award, the gaming system tracks the player's use of the progressive non-monetary award using a non-monetary player award counter. In some embodiments, the gaming system tracks the player's use of the progressive non-monetary award with a non-monetary player award counter, where the non-monetary player award counter correlates to the quantities of remaining award games available for the player to play (also sometimes referred to herein as games with an active progressive non-monetary award or a progressive non-monetary award that is active). It should be appreciated that when the gaming system executes a game with an active progressive non-monetary award or a progressive non-monetary award that is active, the gaming system may be executing plays of the game with one or more special features active, or other suitable non-monetary games or features. In some embodiments, the gaming system does not use the non-monetary player award counter where the progressive non-monetary award does not include awards related to quantities of games.

In some embodiments, the progressive non-monetary award may be a determined quantity of time during which special game features are activated on the gaming system. In some embodiments, the gaming system may convert the accumulated progressive non-monetary award into a period of time. In one embodiment, an average rate of betting on a gaming system may be 12 bets per minute or one bet every 5 seconds. In a non-limiting example, a non-monetary progressive award counter having 25 games accumulated may further convert the accumulated award to a time award of 125 seconds (25 games×5 seconds per game) of game play time where the special game features are active on the gaming system. In some embodiments, a progressive non-monetary award comprises activating a special game feature for some determined time period independent of a quantity of plays of a game that occur during the determined time period. The determined time period can be based on a non-monetary progressive award counter, predetermined, or randomly determined. For example, in some embodiments, triggering a progressive non-monetary award comprises activating an award multiplier for the next 10 minutes (or some other suitable period of time). A player can play 1 game over the next 10 minutes or as many plays of the game as possible over the next 10 minutes, wherein the award multiplier remains active during the 10 minute period and can be applied to one or more of the outcomes of the plays of the game. It should be appreciated that suitable displays will communicate to a player that the non-monetary progressive award has been triggered and the game has entered a time-based mode of play with active special game features available. In this manner, a player is further encouraged to place bets on the gaming system as fast as possible in order to potentially increase the value of awards generated during the progressive non-monetary award payout time.

FIG. 3A illustrates one embodiment in which the gaming system receives a monetary value from a player to initiate operation 300. As indicated in block 305, the gaming system may receive monetary value via a value acceptor device associated with the gaming system. The value acceptor device, in one embodiment, is disposed in a gaming system or in communication with the gaming system as discussed above.

In one embodiment, the gaming system determines a credit balance based on the monetary value received from the player at a value acceptor device as indicated in block 310. The gaming system determines, via a processor, a gaming credit balance for the player. The initial gaming credit balance may be based on the monetary value received from the player at the value acceptor device.

The gaming system, in one embodiment, determines whether a progressive non-monetary award is active on the gaming system as illustrated in block 315. In some embodiments, the gaming system determines, via the processor, a status of the non-monetary player award counter. When the non-monetary player award counter is greater than zero (or some other suitable number) in some embodiments, a progressive non-monetary award is active on the gaming system and play of the game may be altered, as more fully described hereinbelow. In some embodiments, when the non-monetary award counter is equal to zero (or some other suitable number), no progressive non-monetary award is active on the gaming system and operation 300 continues operation via off page connector A which links to FIG. 3B. It should be appreciated that the gaming system may determine the status of whether a progressive non-monetary award is active in other suitable ways.

Turning now to FIG. 3B and off page connector A, the gaming system may receive a wager for a play of a game at the gaming system. In some embodiments, a play of a game begins with a wager and activation of a game and the play of the game ends when the features of the game have completed.

Block 335 of FIG. 3B illustrates one embodiment where a player input device receives the player's wager. The gaming system may allow a player to place a minimum wager, a maximum wager, or any suitable wager amount. Depending on the wager amount, the gaming system may also enable the player to select pay lines across displayed symbol positions on reels in the game in which to place wagers. In some embodiments, the gaming system may select the wagered pay lines automatically based on the player's wager. Wagered pay lines may be referred to herein as active pay lines. In one embodiment, the gaming system may determine whether the player provided enough credits to enable the player's selected wager. The gaming system may prevent the player from placing the wager and starting a play of the game if the player's credit balance is not large enough to support the player's selected wager. If enough credits are not available in the player's credit balance, the gaming system enables the player to insert additional value to obtain the minimum credit level or to cash out of the gaming system in some embodiments.

In one embodiment, the gaming system may use a processor of the gaming system to update a gaming credit balance. The credit balance may be updated in accordance with the player's wager amount as indicated in block 340. In some embodiments, the credit balance is not updated until a later time.

Continuing to block 345, the gaming system processor calculates a non-monetary award contribution. It should be appreciated that awards, whether they are non-monetary or monetary awards, are not free and must be funded either by the house (e.g., a gaming system operator), by players of the gaming system, or some combination of both. However, when a gaming system offers a progressive non-monetary award, a unique challenge arises in determining how to fund the progressive non-monetary awards. This is because each non-monetary award (e.g., one or more games having an active special game feature) may indirectly lead the gaming system to provide an unknown, but statistically predictable monetary award during plays of the game(s) derived from the progressive non-monetary award. Thus, how the calculated portion of the player's wager is used and converted into a non-monetary award contribution can be based on these unknown, but statistically predictable monetary awards that arise from plays of the game in some embodiments, as is discussed below. It should be appreciated that the progressive non-monetary award may be accumulated by any suitable method.

The gaming system may, in some embodiments, build a progressive non-monetary award from one or more individual non-monetary award contributions. In some embodiments, a non-monetary award contribution may be based in part on a prize value of the non-monetary award (i.e., the monetary value of one or more plays of the game in terms of the gaming system operator's cost of providing, or awarding, the one or more plays of the game to the player). As will be further explained hereinbelow, a progressive non-monetary award may comprise a special game feature that is available over a determined quantity of plays of a game where the determined quantity is based on an accumulated number associated with the progressive non-monetary award counter. In some embodiments, the progressive non-monetary award counter represents a determined quantity of plays of the game that the gaming system can award to the player, and the number associated with the progressive non-monetary award counter is progressively accumulated over a period of wagered game plays. In this manner, the gaming system may calculate portions of wagers and convert the portions of wagers into a numeric, non-monetary award contribution, where the non-monetary award contribution (e.g., one or more portions of a play of the game) is added to any existing progressive non-monetary award. One embodiment of the conversion from a monetary value (e.g., the portion of a wager) to a non-monetary number (e.g., one or more portions of a play of a game) is discussed below in more detail.

As can be appreciated, in one embodiment the gaming system may effectively calculate portions of the wager value from the pool of wagers statistically returned to the player as monetary awards based on a theoretical “return to player” percentage or RTP. The percentage “return to player,” or RTP (followed by a numeric percentage, e.g., RTP 92.8%), as utilized herein, refers generally to the theoretical payout percentage, or the return (of monetary value) to players, of a gaming system over a long period of time. The RTP percentage describes the expected ratio of money paid out (to players) to player money wagered at the gaming system. The RTP percentage can also be viewed as defining the hold of the gaming system, where the hold of the gaming system is the amount of money retained by the gaming system (i.e., the casino or “house”, or the “house take”). From a gaming operator's perspective, the RTP percentage can be viewed as defining a cost of operating the game (i.e., the return to the player percentage, or the operator's cost) and a profit (i.e., the house take percentage). For example, an RTP of 92.8% means that over many plays of a gaming system utilizing a particular reel strip set (e.g., symbol sets associated with reels), an average of $92.80 will be paid out for every $100 wagered on the gaming system. The remaining $7.20 wagered on the gaming system will be retained by the house. In a like manner, a RTP of 86% means that over many plays of a game utilizing a particular reel strip set, an average of $86 will be paid out for every $100 wagered on the gaming system. The remaining $14 wagered on the game will be retained by the house. It should be appreciated that the gaming system may use games other than games based on reels and reel strips and still have an RTP percentage.

In one embodiment, a gaming system awarding a progressive non-monetary award (e.g., an awarded feature during a play of a game, etc.), may account for a prize value or a cost of such awarded games because each play of such awarded games has the potential of generating a winning event associated with an award defined by the game pay table and the associated gaming system RTP percentage. In one embodiment, the prize value of a non-monetary award (e.g., an awarded game or awarded games as part of the progressive non-monetary award) may be defined as equal to the face value of a play of the game (e.g., the monetary cost of a play of the game to the player) multiplied by a RTP percentage associated with the game. Thus, in one embodiment, the prize value of a non-monetary award, (e.g., an awarded game) on a gaming system that accepts $1 wagers and has a pay table that generates a 92.8% RTP is $0.928 or 92.8 cents. The prize value of a non-monetary award, (e.g., an awarded game) on a gaming system that accepts $1 wagers and has a pay table that generates 88% RTP is $0.88 or 88 cents. As can be appreciated, the house edge is not considered in the prize value (or game cost) calculation in some embodiments. Therefore, in some embodiments the progressive non-monetary award is effectively funded by portions of the player's wagers remaining after the house edge has been accounted for. In this manner, the progressive non-monetary award is incrementally funded by the player(s) over time from the statistically determined average return of value to the player. In such embodiments, it can be appreciated the gaming system operator does not effectively share in the cost of providing the progressive non-monetary award. It should be appreciated that, in some embodiments, the gaming system can include suitable calculations that allow the gaming system operator to effectively share in the cost of providing the progressive non-monetary award.

Consider a gaming system implementing one embodiment of the progressive non-monetary award described herein. In one embodiment, the gaming system may have symbol sets and one or more pay tables defining a theoretical RTP of 88% (where a house take constitutes the remaining 12%) and the player's cost of one wagered game on the game system is $1. The gaming system calculates the prize value (or game cost) for providing each game of the determined quantity of games awarded by the progressive non-monetary award. In some embodiments, the prize value of an awarded game equals the face value of a play of the game (i.e., the player's wager) multiplied by the RTP associated with the game, or $1 multiplied by 0.88 or $0.88 (88 cents). As can be appreciated from this example, in one embodiment, the gaming system must accumulate $0.88 from received wagers in order to increment the progressive non-monetary award counter by one non-monetary award.

After the gaming system determines the prize value of a non-monetary award, the gaming system may begin accumulating portions of each wager to fund the progressive non-monetary award. In one embodiment, the gaming system may add 8% of an incoming wager to fund the progressive non-monetary award. It should be appreciated that the 8% is illustrative and the example gaming system may take any suitable percentage (e.g., greater than or less than 8%) of an incoming wager to fund the progressive non-monetary award. In one embodiment of the example gaming system having a RTP of 88%, taking 8% of an incoming wager to fund the progressive non-monetary award results in a gaming system configured to provide a house take of 12%, a theoretical RTP of 80%, and the remaining 8% is used to fund the progressive non-monetary award. The gaming system may, in one embodiment, designate some or all of the remaining 8% as the portion of the wager to contribute to the progressive. In one embodiment, the gaming system may then convert the remaining 8% portion of the wager into a non-monetary award contribution.

Continuing with the example gaming system, if $0.08 (8 cents) of every $1 wagered is used as a non-monetary award contribution, the gaming system may increment the progressive non-monetary award counter by a whole number (e.g., increase by one non-monetary award) each time the gaming system accumulates $0.88 for the non-monetary award (recall that $0.88 is the calculated prize value of a non-monetary award in the example gaming system). As can be seen, each $1 wager on the gaming system contributes 1/11 of a non-monetary award (e.g., 1/11 of a play of an awarded game having an active special game feature) into the progressive non-monetary award counter. In some embodiments, if a player wagers $3 on the illustrated gaming system (e.g., the player selects $1 wagers on each of three pay lines), the gaming system contributes 3/11 of a non-monetary award into the progressive non-monetary award counter. In this manner, the non-monetary award contribution may vary in accordance with a player's wager. Thus, the monetary value accumulated from a player's wager to form a non-monetary award contribution may account for a whole award or a fractional award (e.g., play of a game or a fraction portion of a play of a game). Stated differently, in one embodiment the gaming system may increment the progressive non-monetary award counter by the non-monetary award contribution (1/11^{th} of a play of a game having an active special game feature) each time a $1 wager is received by the gaming system with an 88% RTP. In this manner, the gaming system may increment the progressive non-monetary award counter by 1 game at a rate of approximately once per every 11 plays of the game (e.g., when the player wagers $1 per game that has an 88% RTP).

It should be appreciated from the foregoing that by taking a portion of the wager and converting the portion of the wager into a non-monetary award contribution, as described above, the progressive non-monetary award counter may be accumulated or incremented at a faster rate than a comparative monetary progressive award counter (based on a player having to pay $1 for the same play of a game without the progressive non-monetary award). For example, in the illustrated embodiment above, the prize value of each non-monetary award is $0.88 while the face value of this award, to the player, is $1. Thus, the player gains additional value and value potential by playing a gaming system implementing a progressive non-monetary award when compared to a gaming system implementing a monetary progressive award. Stated differently, 275 plays of a gaming system implementing a monetary progressive award building at the rate of $0.08 per game play results in a monetary progressive award value of $22 (275×$0.08=$22), which the player can use to play 22 games. In contrast, 275 plays of a gaming system implementing the progressive non-monetary award described herein (when the progressive non-monetary award is a quantity of games with an active special game feature) results in a progressive non-monetary award of 25 games with active special features. That is to say, 275 contributions of 1/11 of a non-monetary award (or 275/11) results in a quantity of 25 non-monetary awards or games with active special features. Additionally, a progressive non-monetary award of 25 games with active special features provides the potential of 25 additional opportunities to win enhanced monetary awards to the player during the 25 plays of the game. In one embodiment, the gaming system may implement the non-monetary awards as described herein without the need for additional or separate monetary meters and a controller (e.g., a monetary controller, a progressive controller, a central controller) because the progressive award contribution does not need to track money. Rather, the progressive award contribution is made in terms of a fractional non-monetary equivalent of an award game (e.g., 1/11^{th} of an award game). In one embodiment, the gaming system may implement the progressive non-monetary award via counters using the gaming system's memory.

In some embodiments, the gaming system may additionally take portions of wagers and accumulate these portions of wagers in a non-monetary award contribution portion and one or more “seed” non-monetary award contribution portions. That is, the gaming system may further accumulate small amounts of non-monetary award contributions to build a minimum progressive non-monetary award counter, or a progressive non-monetary award seed, which may be accumulated in the background of the gaming system (e.g., not displayed to the player until the progressive non-monetary award seed is used to fund a progressive non-monetary award). The progressive non-monetary award seed may be applied to the progressive non-monetary award counter after a progressive non-monetary award is paid out. In this manner, the gaming system ensures that the progressive non-monetary award counter restarts at the progressive non-monetary seed and remains attractive to players after a prior progressive non-monetary award is triggered.

It should be appreciated that in some embodiments, the gaming system may limit a maximum number that a progressive non-monetary award counter may attain and issue to a player. It may be desirable, in one embodiment, to limit the progressive non-monetary award to a predetermined maximum number because over time, the gaming system may operate for long periods without triggering the progressive non-monetary award. In one such embodiment, the gaming system may continue accumulating non-monetary award contributions from each received wager, and the gaming system may create more than one background progressive non-monetary award seed with the additional non-monetary award contributions. The gaming system may utilize, in some embodiments, a mystery controller (more fully discussed hereinbelow) to limit the maximum number of the progressive non-monetary award counter by triggering issuance of an award when the progressive non-monetary award counter reaches the maximum number. It should be appreciated that in alternative embodiments, the gaming system does not limit a maximum number that a progressive non-monetary award counter may attain and issue to a player.

In some embodiments, the gaming system funds a progressive non-monetary award based on a player's time on the gaming system. For example, in some embodiments, the gaming system may increase the progressive non-monetary award when a player continues to play games at a gaming system after one or more determined periodic time thresholds. For example, in some embodiments, a gaming system may increase a progressive non-monetary award when the player continues to play at a particular gaming system for a predetermined period of time (e.g., 20 minutes or some other suitable period of time). In some embodiments, the gaming system may increase the progressive non-monetary award for one or more predetermined periods of time that the player remains playing games at a particular gaming system.

Returning to operation 300, block 350 indicates the gaming system may increment, via the processor, a progressive non-monetary award counter by the non-monetary award contribution. In some embodiments, as explained above, the non-monetary award contributions may be a fractional number (e.g., in one embodiment, 1/11^{th} of a game for each $1 wagered). The progressive non-monetary award counter may accumulate the fractional number until the counter can increment by a whole number. In this manner, the gaming system increments the progressive non-monetary award counter by one whole number after multiple non-monetary award contributions (e.g., increment the counter by 1 every 11 plays of the game) in some embodiments. As noted above, it should be appreciated that a game's RTP percentage, a player's wager, or some combination of both, or other factors may alter how quickly the gaming system increments the progressive non-monetary award counter.

In one embodiment, the gaming system may display, via a display device, the progressive non-monetary award counter as indicated in block 355. In one embodiment, the gaming system may display the progressive non-monetary award counter as whole number increments. In one embodiment, the gaming system may display the progressive non-monetary award counter as any whole number increments and any fractional increments. In one embodiment, the gaming system may display any fractional increments numerically or via any suitable graphical indication. In this manner, a player may view the progressive non-monetary award counter growth over time after successive plays of the game. The progressive non-monetary award counter growth over time increases player excitement and anticipation of obtaining the progressive non-monetary award. Operation 300 continues via off page connector B to FIG. 3C.

Turning to FIG. 3C and off page connector B, block 360 illustrates one embodiment in which the gaming system may receive a request to initiate a play of a game. The request to initiate the play of the game may be received from a player via a player input device in communication with the gaming system. The gaming system may securely access game data from a memory device and execute an authentication routine on the game data to start a play of a game as discussed above. For example, the player may press a reel spin button on the gaming system to start spinning slot system reels of the gaming system (or randomly generating symbols using other methods discussed above for virtual reels) for the play of the game. It should be appreciated that reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

In one embodiment, the gaming system may use a random number generator to randomly generate a plurality of symbols from one or more sets of symbols as indicated in block 365. In some embodiments, the gaming system may generate the plurality of symbols for display on a set of reels (or virtual reels). As used herein, the random number generation may refer to pseudo-random or true-random number generation depending on the module used for the random number generation.

In one embodiment, the gaming system may cause a display device to display the plurality of symbols generated as indicated in block 370. In a game using reels, the gaming system may display the generated plurality of symbols in visible symbol display areas of each of the reels.

In one embodiment as shown in block 375, the gaming system evaluates the generated plurality of symbols across active or wagered pay lines for winning symbol combinations. In some embodiments, the gaming system evaluates the winning symbol combinations based on the pay lines wagered upon by a player. The gaming system may evaluate the player selected pay lines, gaming system assigned pay lines, or pay lines assigned as active in some other manner for the play of the game. In one embodiment using reels, the gaming system determines an award amount based on winning symbol combinations formed across the reels on active pay lines. For example, if a pay table associated with the game indicates that at least three of the same bar symbols is a winning symbol combination and awards a predetermined payout, the gaming system would evaluate the generated plurality of symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In one embodiment, a pay table may indicate that as few as one symbol may be associated with a payout. Alternatively, two or more symbols may be used to form winning symbol combinations that result in a payout. In some embodiments, the gaming system may use other methods to determine winning symbol combinations, in addition to or in place of using pay lines.

In one embodiment, a pay table for the gaming system may include one or more combination of symbols associated with one award, where the award is the progressive non-monetary award of a determined quantity of games having special game features. In some embodiments, the gaming system does not provide awards other than the progressive non-monetary award when the special game features are not active. For example, in one such embodiment, a play of a game in a standard mode (e.g., without an active special game feature or without an active progressive non-monetary award) may be associated with one available award (e.g., the progressive non-monetary award). Until the progressive non-monetary award is triggered, the gaming system does not provide other awards in some embodiments. In such an embodiment, the player is playing to win the progressive non-monetary award and activate a determined quantity of games having special game features that are available during play of the awarded determined quantity of games. In some embodiments, when the progressive non-monetary award is triggered, and one or more special game features are activated, the gaming system may use at least one second pay table with different awards to evaluate symbols on the gaming system for winning symbol combinations. The at least one second pay table may include one or more awards, including credits, cash, or other suitable awards.

Continuing to block 380, the gaming system determines whether a progressive non-monetary award has been triggered for issuance to the player. In one embodiment, a progressive non-monetary award may be triggered by an evaluation determining that a progressive non-monetary award symbol combination is present on a wagered pay line. When a progressive non-monetary award symbol combination is present on a wagered pay line, the gaming system generates a progressive non-monetary award payout as described more fully hereinbelow. It should be appreciated that any suitable symbol or combination of symbols may be designated as a progressive non-monetary award triggering symbol combination.

Further, it should be appreciated that a progressive non-monetary award may be triggered by any suitable gaming system event. In some embodiments, a progressive non-monetary award may be randomly triggered. In some embodiments, a progressive non-monetary award may be triggered by a mystery controller (not shown). In one embodiment, the control unit 200 may include a mystery controller which controls triggering of a progressive non-monetary award. In one embodiment, the mystery controller may trigger an issuance of a progressive non-monetary award when the progressive non-monetary award counter is above a minimum number. In one embodiment, the mystery controller may award a progressive non-monetary award when the progressive non-monetary award counter is above a minimum number and below a maximum number. In one embodiment, the mystery controller may trigger an issuance of a progressive non-monetary award when the progressive non-monetary award counter reaches a maximum number. In such embodiments, a player may be awarded a progressive non-monetary award because the player is playing the gaming system at the time the mystery controller awards the progressive non-monetary award. It should be appreciated that in some embodiments, the mystery controller may randomly or pseudo-randomly trigger the progressive non-monetary award. In some embodiments, the mystery controller may trigger the progressive non-monetary award based upon a passage of time of gaming system activity. It should be appreciated that any suitable number may be used for the minimum number and/or maximum number. It should further be appreciated that other suitable progressive non-monetary award triggers or combinations of triggers are possible.

When a progressive non-monetary award has not been triggered on the gaming system, operation 300 continues to FIG. 3D via off page connector C.

Turing to FIG. 3D, off page connector C enters at block 385. In block 385, the gaming system may determine, with the processor, any monetary awards (also referred to herein as payout amounts) based on the evaluation for winning symbol combinations across wagered pay lines in block 375. As illustrated in block 385, the gaming system may update, with the processor, the player's gaming credit balance in accordance with any monetary award amount. As noted above, the blocks illustrated in FIGS. 3A-3D can be rearranged in any suitable order. In some embodiments, some of the illustrated blocks may not be used. As such, it should be appreciated that the gaming system may update player's gaming credit balance at other suitable times. In block 385, the gaming system may display, on the display device, any determined monetary awards.

It should be appreciated that in one embodiment, the gaming system may evaluate the plurality of symbols across active pay lines for one or more symbols or a symbol combination that may trigger a bonus game (not shown). In some embodiments, a plurality of bonus games may be available to the player. In some embodiments, the one or more symbols or a symbol combination that triggers the bonus game do not need to appear on wagered pay lines. In some embodiments, the one or more symbols or a symbol combination that may trigger a bonus game may be a predetermined symbol or symbols, or a predetermined combination of symbols. It should be appreciated that in some embodiments, events other than generating one or more symbols or a symbol combination may trigger the bonus game. In the interest of brevity, embodiments of a gaming system having a progressive non-monetary award are discussed herein in combination with a base game. However, gaming systems having base games and bonus games may utilize the concepts discussed herein.

Returning to FIG. 3D, operation 300 moves to block 390. In one embodiment, as indicated in block 390, the gaming system may receive a request or a signal to end game play or “cash out” via an input device of the gaming system. In such a situation, the gaming system dispenses a value to the player, through a value dispenser, based on the player's gaming credit balance as illustrated in block 395 and operation 300 ends.

On the other hand, if the gaming system processor has not received a request or signal to end game play via the player input device, operation 300 returns to block 315 of FIG. 3A via off page connector D. Recall that in block 315, in one embodiment, the gaming system determines whether a progressive non-monetary award is active on the gaming system. When no progressive non-monetary awards are active on the gaming system, operation 300 proceeds via off page connector A to block 335 of FIG. 3B where the gaming system may receive, via a player input device, a wager for another play of the game and continue operation 300 from block 335. However, in one embodiment, the wager may not be accepted if the player has fewer credits than the player's selected wager amount as shown in block 335.

In one embodiment, operation 300 and play of the game may continue as described above, moving through blocks 340, 345, 350, 355, 360, 365, 370 and 375 to block 380. The gaming system, via the processor, may increment the progressive non-monetary award counter by the non-monetary award contribution each time a wager is received via the player input device. It should be appreciated that in some embodiments, over time, the progressive non-monetary award counter may grow to a number that greatly increases player excitement and anticipation.

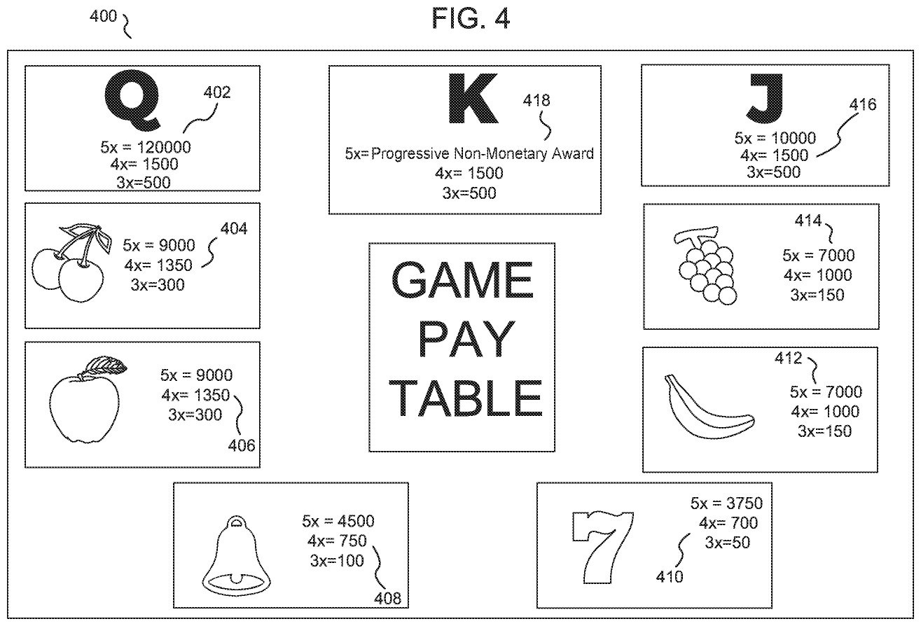

Returning now to block 380 of FIG. 3C, the gaming system determines whether a progressive non-monetary award has been triggered. As described hereinabove, in some embodiments the progressive non-monetary award may be triggered based upon the evaluation of the generated plurality of symbols and the pay table while in some other embodiments the progressive non-monetary award may be triggered by a mystery controller. It should be appreciated that other suitable triggering events may be implemented on the gaming system. When the gaming system determines that the progressive non-monetary award triggering event has occurred such as, in one embodiment, a symbol or combination of symbols are present on the evaluated wagered pay lines (e.g., the gaming system generated five K symbols on a wagered pay line as shown in an example pay table 400 of FIG. 4), operation 300 moves to block 382.

In one embodiment, the gaming system may issue the progressive non-monetary award as indicated in block 382. The gaming system may issue the progressive non-monetary award by incrementing a non-monetary player award counter in accordance with the progressive non-monetary award counter. In other words, some or all of the non-monetary awards accumulated by the progressive non-monetary award counter in each pass through block 350 of operation 300 (i.e., sustained play of the game over time) may be transferred to the non-monetary player award counter. When the non-monetary player award counter is greater than zero, the gaming system will determine that a progressive non-monetary award is active on the gaming system in some embodiments (e.g., at block 315). In alternative embodiments, when the non-monetary player award counter is greater than zero, the gaming system will not determine that a progressive non-monetary award is active unless the player selects to use the available non-monetary progressive awards in the non-monetary player award counter.

Continuing in block 382, in one embodiment the gaming system may, after issuing of the progressive non-monetary award, reset the progressive non-monetary award counter. In some embodiments, the gaming system may reset the progressive non-monetary award counter to zero. In some embodiments, the gaming system may reset the progressive non-monetary award counter to a progressive non-monetary award seed, as more fully described hereinbelow.

Block 382 also illustrates that, in some embodiments, the gaming system may show, via the display, the issuing of the progressive non-monetary award and resetting of the progressive non-monetary award counter. In one embodiment, the gaming system may congratulate the player and update the displayed progressive non-monetary award counter. In one embodiment, the gaming system may display the progressive non-monetary award being issued to the player by incrementing a non-monetary player award counter display and decrementing a displayed progressive non-monetary award counter. It should be appreciated that any suitable display depicting the progressive non-monetary award issuance may be used.

It should further be appreciated that because the award is a non-monetary award, the player's gaming credit balance is not altered or updated in relation to the gaming system issuing a progressive non-monetary award to the player in some embodiments.

In some embodiments, the gaming system may issue the progressive non-monetary award based upon an occurrence of a winning symbol combination as illustrated by the pay table of FIG. 4. The pay table of FIG. 4 represents an example pay table for a five-reel gaming system. In one embodiment, the gaming system issues the progressive non-monetary award when 5 occurrences of the K symbol are displayed across an active or wagered pay line. In some embodiments, the gaming system may issue other progressive non-monetary awards (not shown) when different symbol combinations occur. In some embodiments, the gaming system may issue a different (non-monetary) progressive award, as described more fully hereinbelow, when additional symbol combinations occur. As can be appreciated, the gaming system may set appropriate flags (not shown) or suitably store in a memory device the type of progressive non-monetary award achieved. It should be appreciated that any suitable variety of pay tables with any suitable awards for a variety of symbol combinations can be used with the gaming system.

One embodiment of an operation of the gaming system after the player obtained a progressive non-monetary award is now described.

If the gaming system has not received a request or a signal to end game play via a player input device (e.g., player control button area 114) after obtaining the progressive non-monetary award, operation 300 returns to block 315 in FIG. 3A. In block 315, in one embodiment, the gaming system determines whether a progressive non-monetary award is active on the gaming system. In block 315, the gaming system determines, via the processor, whether the non-monetary player award counter is above a predetermined number. As previously indicated in block 382 of FIG. 3C, the gaming system incremented the non-monetary player award counter in accordance with the progressive non-monetary award counter when the progressive non-monetary award was issued to a player.

Moving to block 325, in some embodiments, triggering the progressive non-monetary award may cause the gaming system to activate a special game feature that is available over a determined quantity of plays of the game. In some embodiments, the determined quantity of plays of the game may be based on the progressive non-monetary award counter. In some embodiments, the determined quantity of plays of the game may be a predetermined number. The progressive non-monetary award may cause the gaming system to activate a special game feature that may only be available to the player during a progressive non-monetary award in some embodiments.

In some implementations, a play of a game begins with a wager and activation of a game and the play of the game ends when the features of the base, bonus, or both have completed (depending on whether a bonus game is played). In another implementation, one play of a game comprises the processor executing blocks 315-385 and terminating at either block 390 or 395. In some implementations, block 390 and block 395 are not part of a play of a game. In alternative implementations, block 390 and block 395 are part of a play of a game.

In some embodiments, the special game feature may be an award multiplier applied to monetary awards achieved during the determined quantity of plays of the game on the gaming system. The award multiplier may be equal to or based upon the displayed progressive non-monetary award counter at the time the progressive non-monetary award is triggered. In some embodiments, the determined quantity of games may be equal to or based upon the progressive non-monetary award counter at the time the progressive non-monetary award is triggered. In such embodiments, a progressive non-monetary award counter having a count of 23 at the time the progressive non-monetary award is triggered may result in the gaming system applying a 23× multiplier to any monetary awards achieved during the next 23 plays of the game on the gaming system. In some embodiments, the gaming system may apply a predetermined award multiplier to a determined quantity of games where the determined quantity of games is equal to or based upon the progressive non-monetary award counter. In such embodiments, a progressive non-monetary award counter of 23 at the time the progressive non-monetary award is triggered may result in a 5× multiplier (e.g., when the predetermined award multiplier is 5×) being applied to any monetary awards achieved during the next 23 plays of the game on the gaming system. It should be appreciated that in some embodiments, the award multiplier may be randomly selected from a predetermined range of multipliers, and the determined quantity of games may be based on the number displayed in the progressive non-monetary award counter at the time the progressive non-monetary award is triggered. In yet other embodiments, the gaming system may apply the progressive non-monetary award counter to the award multiplier for a predetermined quantity of plays of the game. In such embodiments, a progressive non-monetary award counter having a count of 23 at the time the progressive non-monetary award is triggered may result in a 23× multiplier being applied to any monetary awards achieved during the next 10 (e.g., when the determined quantity of plays of the game is predetermined to be 10) plays of the game on the gaming system.

In some embodiments, the special game feature associated with a progressive non-monetary award may be one or more symbols that can be held during a determined quantity of plays of the game on the gaming system when the gaming system generates and displays the preselected symbol. The one or more symbols that can be held can be randomly determined or predetermined in some embodiments. In some embodiments, the determined quantity of plays of the game may be equal to or based upon the progressive non-monetary award counter at the time the progressive non-monetary award is triggered. In some embodiments, the quantity of plays of the game may be predetermined. During a play of the game with an active special game feature (part of a progressive non-monetary award), the gaming system may generate a hold symbol. When the gaming system generates the hold symbol, in one embodiment, the gaming system may hold or lock the generated hold symbol in a symbol position area through a quantity of additional reel re-spins (where the additional reel re-spins are separate from and in addition to the determined quantity of games). In one embodiment, the quantity of additional reel re-spins may be determined based on the progressive non-monetary award counter at the time the progressive non-monetary award is triggered. In one embodiment, the quantity of reel re-spins may be predetermined. While the symbol hold special game feature is active, when a hold symbol is randomly generated, the gaming system may, in some embodiments, additionally re-spin the reels for a predetermined quantity of additional reel re-spins without any player input. In some embodiments, the progressive non-monetary award includes free games with the symbol hold feature.

In one such embodiment with a symbol hold feature, the gaming system may award a quantity of 15 plays of the game when the progressive non-monetary award is triggered. During the gaming system's execution of the 15 plays of the game, the gaming system may execute all 15 plays of the game without generating and displaying the hold symbol. However, during each of the 15 plays of the game, the gaming system may evaluate the generated symbols along preselected pay lines for additional winning symbol combinations and award any obtained associated monetary awards. During any one of the 15 plays of the game, however, the gaming system may randomly generate and display one or more hold symbols (e.g., a WILD symbol) and the gaming system may initiate the hold and re-spin feature for the hold symbol. In one embodiment, random generation and display of the preselected symbol may cause the gaming system to hold the generated hold symbol and initiate a quantity of additional reel re-spins (where the additional reel re-spins are in addition to and separate from the determined quantity of plays of the game from the progressive non-monetary award). The gaming system may initiate the additional reel re-spins without input from the player. In one embodiment, the gaming system may provide 15 additional reel re-spins where the hold symbol is held in place (e.g., the held symbol is not moved during re-spins or the gaming system returns to the held symbols to the same symbol display position after each additional reel re-spin). During additional reel re-spins, the gaming system may evaluate the held symbol along wagered pay lines for winning outcomes that result in monetary payouts. In some embodiments, the gaming system may additionally re-spin the reels a predetermined quantity of times each time a held symbol is generated. For example, the gaming system may additionally re-spin the reels 5 times after a held symbol is generated. It should be appreciated that the gaming system may additionally re-spin the reels any suitable quantity of times after a hold symbol is generated. It should also be appreciated that the gaming system may apply the symbol hold feature to the remaining determined quantity of games without triggering any additional reel re-spins.

In one embodiment, the preselected symbol may be a WILD symbol for the symbol hold game of the progressive non-monetary award. It should be appreciated that any other symbol may be selected for the symbol hold game of the progressive non-monetary award. It should further be appreciated that the gaming system may randomly determine a symbol to use for the hold symbol each time the symbol hold special game feature is achieved with a progressive non-monetary award.

Returning to block 325, the gaming system activates the special game feature for a play of the game and decrements the non-monetary player award counter. In one embodiment, the gaming system activates the special game feature after determining, if necessary, which progressive non-monetary award is active. It should be appreciated that more than one progressive non-monetary award may be active on the gaming system simultaneously. After the gaming system activates the special game feature for a play of the game and decrements the non-monetary player award counter, operation 300 flows via off page connector A to FIG. 3B and to block 335 where the gaming system receives, via a player input device, a wager for a play of a game. Play of the game may continue as outlined in operation 300 from blocks 335-385. However, continued game play is dependent on the number of credits remaining in the player's credit balance. The player may also choose to request to cash out, as illustrated in block 390. If the player chooses to cash out, the gaming system may provide the player a monetary value based on the player's credit balance using any of the value items discussed above (bills, coins, vouchers, etc.). In some embodiments, if the player chooses to cash out with the non-monetary player award counter quantity greater than zero (e.g., additional plays of the game from the progressive non-monetary award are still available), the gaming system may store a remaining count of player's non-monetary player award counter in memory, in a player tracking card, with a player tracking server, or using some other suitable storage mechanism. In one embodiment, the gaming system may erase any quantity contained on the non-monetary player award counter such that a player may forfeit the remainder of any progressive non-monetary award when electing to cash-out of the gaming system.

It should be appreciated that the non-monetary active special game features described above are merely illustrative of progressive non-monetary awards, and the gaming system may award any suitable special game feature as a non-monetary award.

FIG. 4 illustrates a screen shot of one embodiment of a pay table 400 for winning symbol combinations across wagered pay lines of the first set of reels. Tables 402, 404, 406, 408, 410, 412, 414, 416, and 418 are merely example payout awards for example winning symbol combinations. As noted above, it should be appreciated that the pay table is merely illustrative, and the symbols and payout awards may be modified in any suitable manner. It should be appreciated that a pay table may include any suitable number of winning symbol combinations and payout awards. In one embodiment, a pay table may indicate that as few as one symbol may be associated with a payout award. Alternatively, two or more symbols may be used to form winning symbol combinations that result in a payout award.

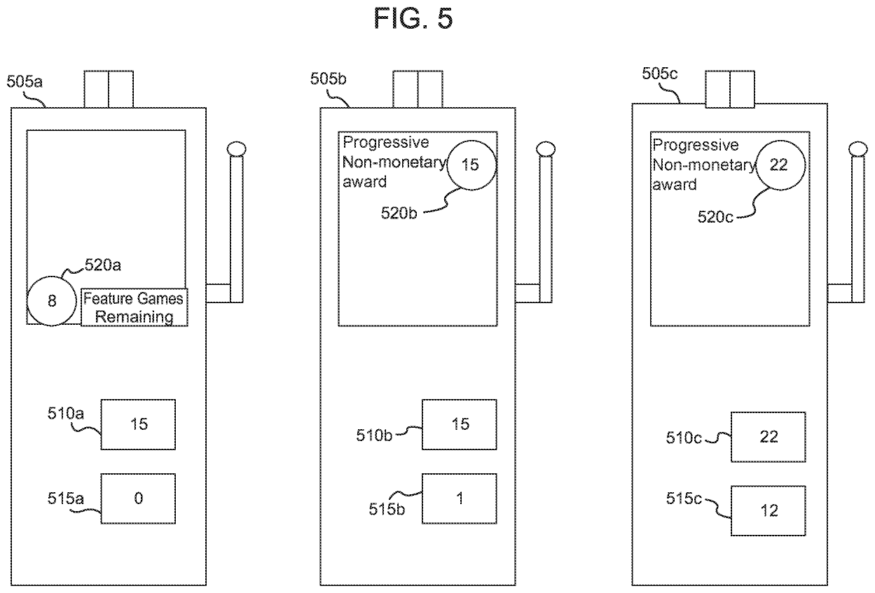

Turning now to FIG. 5, the FIG. 5 illustrates a plurality of stand-alone gaming systems having a progressive non-monetary award. FIG. 5 illustrates one embodiment of gaming system 505a, 505b, and 505c operating as stand-alone non-monetary progressive gaming systems. A stand-alone non-monetary progressive gaming system is a gaming system that operates a non-monetary progressive gaming award exclusive to the gaming system. Because stand-alone non-monetary progressive gaming systems are not linked to other gaming systems for purposes of a progressive non-monetary award in some embodiments, the progressive non-monetary award cannot be won by a player on another gaming system.

In FIG. 5, gaming systems 505a, 505b, and 505c are illustrated in different operating points along operation flow 300 described above. Gaming system 505a is illustrated in operation during an active progressive non-monetary award (e.g., providing an awarded quantity of games with active special game features). Gaming system 505b is illustrated in operation after a progressive non-monetary award execution has concluded, where the progressive non-monetary award counter has been reset with the progressive non-monetary award seed and a new progressive non-monetary award seed accumulation has begun. Gaming system 505c is illustrated in operation after a number of plays of a game without the triggering of a progressive non-monetary award, as illustrated by the accumulation of progressive non-monetary award counter and progressive non-monetary award seed counter. Operation of gaming systems 505a, 505b, and 505c will now be more fully described.

As noted above, in some embodiments, the gaming system may accumulate one or more progressive non-monetary award seeds in addition to accumulating the progressive non-monetary award. In some embodiments, portions of wagers may be accumulated until a progressive non-monetary award seed reaches a predetermined number. In some embodiments, the gaming system uses the progressive non-monetary award seed to replenish the progressive non-monetary award by moving the progressive non-monetary seed to the progressive non-monetary award counter after a progressive non-monetary award is issued to a player (e.g., to avoid the progressive non-monetary award starting at zero). For ease of description of FIG. 5, the progressive non-monetary award seed is set as 15. It should be appreciated that in other embodiments, any suitable seed number can be used for the progressive non-monetary award seed.

Gaming system 505a illustrates a stand-alone non-monetary progressive gaming system having a progressive non-monetary award where a progressive non-monetary award is active on the gaming system (e.g., the gaming system is executing plays of a game associated with the progressive non-monetary award) as indicated by display 520a. In one embodiment, the gaming system includes a display 520a illustrating that 8 games remain on the non-monetary player award counter. Recall that upon a progressive non-monetary award triggering event that results in the gaming system issuing the progressive non-monetary award to a player, in one embodiment, the gaming system may transfer the progressive non-monetary award to the player by incrementing a non-monetary player award counter by at least a portion of the progressive non-monetary award counter, as explained above in relation to block 382 of FIG. 3C. In some embodiments, upon the progressive non-monetary award triggering event, the gaming system may also transfer a stored progressive non-monetary award seed to the progressive non-monetary award counter. In the illustrated embodiment, gaming system 505a shows a progressive non-monetary award counter 510a having an accumulated quantity of 15. Gaming system 505a also shows a progressive non-monetary award seed counter 515a having an accumulated quantity of 0. It should be appreciated that in some embodiments any suitable quantity of progressive non-monetary seeds may be accumulated and incremented in the background, according to the operation outlined above, to create sufficient progressive non-monetary award funding in the event of gaming system 505a issuing successive progressive non-monetary awards in a short period of time. It should also be appreciated that the counters 510a and 515a are internal to the gaming system and are not displayed to the player in some embodiments. Rather, the quantity of counter 510a is displayed to the player via display 520a, discussed below.

As a result of a progressive non-monetary award being active on gaming system 505a, gaming system 505a has previously awarded the player the determined quantity of plays of the game (associated with the issued progressive non-monetary award) and has reset the progressive non-monetary award counter 510a with a progressive non-monetary award seed of 15 in preparation for a return to standard plays of the game (e.g., not associated with the progressive non-monetary award). After the player has completed the remaining 8 plays associated with the progressive non-monetary award, the gaming system may reset display 520a to show the new progressive non-monetary award counter at 15 (e.g., the progressive non-monetary award seed). Gaming system 505a may begin increasing the progressive non-monetary award counter and progressive non-monetary seed counter on subsequent plays of the game. It should be appreciated that in some embodiments, the gaming system does not accumulate contributions to the progressive non-monetary award or to the progressive non-monetary award seed during play of awarded quantities of games.

Gaming system 505b illustrates a stand-alone non-monetary progressive gaming system having a progressive non-monetary award where a progressive non-monetary award has recently been issued and used (played) or completed, and gaming system 505b has resumed a standard play of the game (e.g., operation without an active progressive non-monetary award or active special game feature). As illustrated in FIG. 5, gaming system 505b includes a display 520b illustrating that the gaming system 505b will award 15 games, based on a progressive non-monetary award seed of 15, when the progressive non-monetary award payout is triggered. Progressive non-monetary award counter 510b illustrates 15 progressive non-monetary award games will be awarded if a progressive non-monetary award is triggered on a next play of the game. It should be appreciated that gaming system 505b may contain additional fractional non-monetary award contributions to progressive non-monetary award counter 510b although progressive non-monetary award counter 510b has not yet incremented. In some embodiments, the gaming system may display any accumulated fractional non-monetary awards quantities on display 520b. Gaming system 505b is also illustrated as building a progressive non-monetary award seed to fund future progressive non-monetary awards, as indicated in progressive non-monetary award seed counter 515b. In one embodiment, a low progressive non-monetary award seed as illustrated in counter 515b indicates the gaming system has recently issued a progressive non-monetary award. It should be appreciated that in some embodiments the gaming system may accumulate any suitable quantity of progressive non-monetary award seeds (which may not be visible to a player), according to the operation outlined above, to create sufficient progressive non-monetary award funding in the event of successive progressive non-monetary award triggering and issuance in a short period of time. It should also be appreciated that the counters 510b and 515b are internal to the gaming system and are not displayed to the player in some embodiments.

Gaming system 505c illustrates yet another stand-alone gaming system having progressive non-monetary awards. In one embodiment, gaming system 505c includes a display 520c illustrating that the gaming system 505c will award 22 games when the progressive non-monetary award is triggered. Progressive non-monetary award counter 510c also reflects a progressive non-monetary award of 22 although, as noted above, the progressive non-monetary award counter 510c may additionally hold fractional contributions to the progressive non-monetary award that have not yet been reflected in the progressive non-monetary award counter 510c because the fractional contributions do not yet amount to a whole number. It should be appreciated that the gaming systems may display both the whole number progressive non-monetary award as well as any accumulated fractional contributions to the progressive non-monetary award. Gaming system 505c has built a progressive non-monetary award seed of 12, as indicated by progressive non-monetary award seed counter 515c. Gaming system 505c has not awarded a progressive non-monetary award after an extended period of game play, as evidenced by the large progressive non-monetary award counter and the large progressive non-monetary award seed counter. It should also be appreciated that the counters 510c and 515c are internal to the gaming system and are not displayed to the player in some embodiments.

In some embodiments, the gaming system may limit the maximum number that a progressive non-monetary award counter may attain and pay out to a player. It may be desirable, in one embodiment, to limit the progressive non-monetary award because over time, the gaming system may operate for long periods without triggering the progressive non-monetary award. In such embodiments, the gaming system may continue accumulating non-monetary award contributions from received wagers, and the gaming system may create more than one progressive non-monetary award seed with the additional non-monetary award contributions.

In some embodiments, the gaming systems 505a, 505b, and 505c may implement the progressive non-monetary awards as described herein without the need for additional or separate monetary meters or a controller (e.g., a monetary controller, a progressive controller, or a central controller) because the non-monetary award contributions are made in terms of a fractional non-monetary equivalent cost of an award game. In one embodiment, each of gaming systems 505a, 505b, and 505c may track and accumulate their respective progressive non-monetary awards via counters and does not require the addition of a monetary controller or the addition of a central controller to track money contributed to a monetary progressive award.

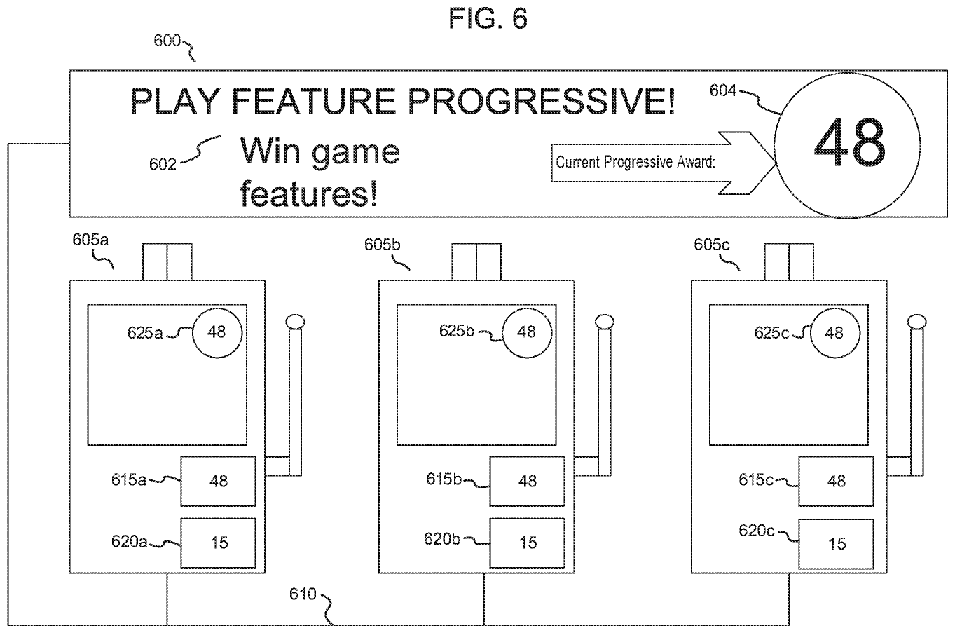

Turning to FIG. 6, a plurality of linked gaming systems having progressive non-monetary awards and including an overhead progressive non-monetary award display are illustrated. FIG. 6 illustrates one embodiment of gaming systems 605a, 605b, and 605c operating as linked gaming systems. Linked gaming systems are gaming systems linked into a networked arrangement to create and share a progressive non-monetary award. In one embodiment, each linked gaming system contributes their own non-monetary award contributions from wagers at the linked gaming systems for a common progressive non-monetary award. The progressive non-monetary award can be triggered by and awarded to a player located at any one of the linked gaming systems. Linked gaming system progressive non-monetary award arrangements introduce a sense of anticipation, urgency, and competition between players as the progressive non-monetary award grows.

In one embodiment, gaming systems 605a, 605b, and 605c may be linked by communications network 610. Although only three gaming systems are illustrated in FIG. 6, in some embodiments it is possible to link two gaming systems or to link more than three gaming systems. Communications network 610 provides bi-directional communications between each linked gaming system and overhead display 600. In some embodiments, each gaming system may communicate over communications network 610 via a suitable network interface controller 224 as illustrated in FIG. 2 and described hereinabove.

Gaming system 605a includes progressive non-monetary award counter 615a, progressive non-monetary award seed counter 620a, and progressive non-monetary award display 625a. Gaming system 605b includes progressive non-monetary award counter 615b, progressive non-monetary award seed counter 620b, and progressive non-monetary award display 625b. Gaming system 605c includes progressive non-monetary award counter 615c, progressive non-monetary award seed counter 620c, and progressive non-monetary award display 625c. The progressive non-monetary award counters 615 and the progressive non-monetary award seed counters 620 are shown as visible in FIG. 6 for ease of discussion. In some embodiments, the non-monetary award counters 615 and the progressive non-monetary award seed counters 620 are not visible to a player, while in other embodiments they are visible to a player. Each of gaming systems 605a, 605b, and 605c is connected to communications network 610. In one embodiment, an overhead display 600 may be connected to communications network 610.

In some embodiments, overhead display 600 may be disposed or located above a group of linked gaming systems, or in any suitable location to communicate the progressive non-monetary award to players. In one embodiment, overhead display 600 may include an informative display area 602. Overhead display 600 may further include display area 604 for displaying the progressive non-monetary award counter for the linked gaming systems. With this arrangement, players may ascertain the progressive non-monetary award for the linked gaming systems from a distance. As the progressive non-monetary award grows, player interest may increase, and more players may be attracted to play the linked gaming systems. In some embodiments, the group of linked gaming systems does not incorporate an overhead display 600.

In some embodiments, when a player places a wager at one of a plurality of linked gaming systems, such a gaming system, via a processor, may take a portion of the player's wager and increment the progressive non-monetary award counter by a non-monetary award contribution to accumulate a progressive non-monetary award as described above in relation to operation 300 in FIGS. 3A-3D. In some embodiments, the linked gaming system may additionally communicate the non-monetary award contribution to all gaming systems linked via communications network 610 in a communication broadcast. For example, one of the gaming systems may broadcast or transmit a data packet that may be received by every gaming system connected to the network (e.g., all-to-all communication). Communications over communications network 610 may be managed via a suitable network interface controller 224 as illustrated in FIG. 2 and described hereinabove. It should be appreciated that communications network 610 may be implemented and managed by other suitable network topography and communication protocol arrangements (e.g., ethernet, TCP/IP, token passing).

In one embodiment, gaming system 605a may broadcast or transmit, via communications network 610, messages communicating each received wager's non-monetary award contribution quantity to all linked gaming systems. Gaming system 605a may also receive, via communications network 610, messages communicating the non-monetary award contribution from wagers placed on and transmitted from at least one other linked gaming system. Gaming system 605a may update progressive non-monetary award counter 615a, progressive non-monetary award seed counter 620a, and progressive non-monetary award display 625a, to reflect all received non-monetary award contributions. In a similar manner, gaming system 605b is broadcasting (transmitting), receiving, and updating progressive non-monetary award counter 615b, progressive non-monetary award seed counter 620b, and progressive non-monetary award display 625b, and gaming system 605c is broadcasting (transmitting), receiving, and updating progressive non-monetary award counter 615c, progressive non-monetary award seed counter 620c, and progressive non-monetary award display 625c. Overhead display 600 may be constantly receiving non-monetary award contributions and updating the progressive non-monetary award displayed in display area 604.

As can be appreciated, in a linked gaming system progressive non-monetary award arrangement, each gaming system can contribute to a progressive non-monetary award that is available for gaming systems in the linked arrangement to win, and any reel spin on a linked gaming system may trigger the progressive non-monetary award. In this manner, linked progressive non-monetary awards may grow very rapidly and may grow very large as illustrated in the representative number of 48 shown in respective progressive non-monetary award display areas 604, 625a, 625b, and 625c in FIG. 6.

In some embodiments, upon the occurrence of the progressive non-monetary award triggering condition on any one of the linked gaming systems, the gaming system generating the triggering condition may lock the progressive non-monetary award held in the progressive non-monetary award counter and displayed on the progressive non-monetary award display of the triggering gaming system. The gaming system may also transmit a signal to all linked gaming systems indicating that the progressive non-monetary award is locked. As each linking gaming system receives the transmitted notification of the triggering condition and lock notice, each gaming system may reset their respective progressive non-monetary award counters, progressive non-monetary award seed, and update the respective progressive non-monetary award displays reflecting a progressive non-monetary award has been reset. In some embodiments, the progressive non-monetary award is reset to a predetermined minimum maintained in one or more progressive non-monetary award seed counters. The gaming system generating the triggering condition may transfer the locked progressive non-monetary award from a progressive non-monetary award counter to a non-monetary player award counter, as described above in relation to block 382 of FIG. 3C and operation of the gaming system that triggered the progressive non-monetary award continues as outlined in an active progressive non-monetary award to operation 300 of FIGS. 3A-3D.

In some embodiments, more than one linked gaming system may trigger a progressive non-monetary award in rapid succession. In one embodiment, the linked gaming systems may additionally contribute to one or more progressive non-monetary award seeds as indicated by progressive non-monetary award seed counters 620a, 620b, and 620c. Although only one progressive non-monetary award seed counter is illustrated for each of gaming systems 605a, 605b, and 605c in FIG. 6, it should be appreciated that any suitable quantity of progressive non-monetary award seed counters may be utilized to ensure appropriate progressive non-monetary award minimum levels are provided for in the event that one or more progressive non-monetary awards are issued substantially simultaneously or in close succession by the linked gaming systems.

It is noted that like an embodiment of a stand-alone gaming system having progressive non-monetary awards discussed above in relation to FIG. 5, the linked gaming systems may implement the progressive non-monetary awards as described herein without the need for expensive additional or separate monetary meters and a controller (e.g., a monetary controller, a progressive controller, a central controller) because the non-monetary award contribution is made in terms of a fractional non-monetary equivalent of an award game and not in terms of monetary credits or currency. In one embodiment, each gaming system may implement the progressive non-monetary award via counters, and network communications may be implemented with network interface controller 224. Thus, a plurality of linked gaming systems may implement a progressive non-monetary award independent of a centralized progressive controller Eliminating the expensive additional or separate monetary meters and controllers reduces the cost to implement progressive non-monetary award system Eliminating the expensive additional or separate monetary meters and controllers also improves the efficiency because fewer components are necessary to implement the progressive non-monetary award system.

It should be appreciated that although a single progressive non-monetary award has been described for both the stand alone gaming system and linked gaming systems discussed herein, in some embodiments a plurality of progressive non-monetary awards may be included on stand alone or linked gaming system. Further, it should be appreciated that a combination of stand-alone and linked progressive non-monetary awards may be created. In some embodiments, a plurality of progressive non-monetary awards may be available where one (or more) of the progressive non-monetary awards are funded via the stand-alone gaming system (e.g., funded by play of the game and available to the player of the game) and (one or more) of the progressive non-monetary awards are funded via a plurality of linked gaming systems (e.g., funded by players of the linked games and available to any player on any one of the linked games). In some embodiments, some available non-monetary awards are funded by the house. Creating a plurality of progressive non-monetary awards with both stand alone and linked progressive non-monetary awards greatly enhances player anticipation and excitement.

As can be appreciated from the discussion herein, gaming systems having a progressive non-monetary award may provide exciting new game play for players. In some embodiments, the gaming system may quickly build attractive progressive non-monetary awards. In some embodiments, the gaming systems may be linked to provide larger progressive non-monetary awards and greatly enhance player excitement for a game. It should be appreciated that the progressive non-monetary award can be applied to slot based games and non-slot based games. Gaming systems may implement the progressive non-monetary awards on stand-alone systems or on linked systems without an additional progressive controller, thereby providing substantial cost reductions and gaming system operation efficiency. A gaming system having progressive non-monetary awards offers players new ways to obtain game awards and enhances players' excitement for a game. Moreover, by providing a determined quantity of games with one or more active special game features otherwise unavailable to a player, the gaming system offers players even greater new ways to obtain game awards. The new potential to improve or earn greater awards creates a greatly improved sense of anticipation for players.

A number of embodiments of the invention have been described. Various modifications may be made without departing from the spirit and scope of the invention. For example, various forms of the flows shown above may be used, with steps re-ordered, added, or removed. Accordingly, other embodiments are within the scope of the following claims.

We claim:

1. A gaming system comprising:
a cabinet;
a processor;
a display device;
an input device;
a value acceptor;
a value dispenser;
a memory device that stores a plurality of instructions which, when executed by the processor, cause the processor to:
establish a credit balance based at least in part on a monetary value received by the value acceptor;
issue a progressive non-monetary award upon an occurrence of a triggering condition in a play of a game;
place a wager following receipt of a wager input via the input device for a second play of the game, the credit balance being decreased by the wager;
activate a special game feature based on the progressive non-monetary award for the second play of the game;
execute the second play of the game based on the issued progressive non-monetary award and the wager;
determine a monetary award for the second play of the game based on the issued progressive non-monetary award and the wager;
increase the credit balance by the determined monetary award;
issue value from the value dispenser based on the credit balance upon receipt of a cash out request.

2. The gaming system of claim 1, wherein the processor further:
calculates a variable non-monetary award contribution;
increments a progressive non-monetary award counter by the non-monetary award contribution for the progressive non-monetary award,
wherein the non-monetary award contribution is based on a prize value of a non-monetary award, and the prize value of the non-monetary award is based on a face value of a play of the game multiplied by a theoretical return to player value associated with the game.

3. The gaming system of claim 1, wherein the progressive non-monetary award further comprises a determined quantity of games.

4. The gaming system of claim 1, wherein the progressive non-monetary award is a special game feature that is available over a determined quantity of plays of the game.

5. The gaming system of claim 4, wherein the special game feature is an award multiplier applied to awards achieved during the determined quantity of plays of the game.

6. The gaming system of claim 5, wherein the award multiplier is predetermined.

7. The gaming system of claim 5, wherein the award multiplier is based on the progressive non-monetary award.

8. The gaming system of claim 5, wherein the special game feature is a symbol hold for one or more symbols during the determined quantity of plays of the game.

9. The gaming system of claim 8, wherein the symbol hold locks a randomly generated hold symbol in a symbol display area during the determined quantity of plays of the game.

10. The gaming system of claim 5, wherein the determined quantity of plays of the game are plays of the game that require a wager.

11. The gaming system of claim 2, wherein at least two calculations of non-monetary award contributions occur, and wherein one of the calculations comprises a primary non-monetary award contribution and another one of the calculations of non-monetary award contributions comprises a seed contribution.

12. The gaming system of claim 11, further comprising:
a seed counter, wherein the seed counter is incremented by the seed contribution until the seed counter reaches a predetermined minimum number.

13. The gaming system of claim 2, further comprising a communication link to at least a second gaming system,
wherein the processor further:
transmits to the second gaming system a number associated with the progressive non-monetary award counter;
receives, from the second gaming system, a second number associated with a second progressive non-monetary award counter;
increments the progressive non-monetary award counter by the second number to form an updated progressive non-monetary award; and
wherein issuing the progressive non-monetary award further comprises issuing the updated progressive non-monetary award.

14. The gaming system of claim 13, further comprising a common display that displays the updated progressive non-monetary award, wherein the common display is in communication with the gaming system and the second gaming system.

15. The gaming system of claim 13, further comprising a plurality of gaming systems in communication over the communication link; wherein each gaming system has a plurality of different progressive non-monetary awards,
wherein at least some of the plurality of gaming systems transmit messages to and receive messages from the other plurality of gaming systems regarding different non-monetary award contributions.

16. The gaming system of claim 15, wherein the plurality of gaming systems communicate the different non-monetary award contributions independent of a centralized progressive controller.

17. The gaming system of claim 2, wherein the non-monetary award contribution comprises one or more portions of the progressive non-monetary award.

18. The gaming system of claim 2, wherein the triggering condition is randomly determined after the progressive non-monetary award counter reaches a minimum number.

19. A method of operating a gaming system, the method comprising:
receiving, by a monetary value acceptor, a monetary value;
establishing, by a processor of the gaming system, a credit balance based at least in part on the received monetary value;
issuing a progressive non-monetary award upon an occurrence of a triggering condition in a play of a game;
placing a wager following receipt of a wager input via an input device for a second play of the game, the credit balance being decreased by the wager;
activating a special game feature based on the progressive non-monetary award for the second play of the game;
executing the second play of the game based on the issued progressive non-monetary award and the wager;
determining a monetary award for the second play of the game based on the issued progressive non-monetary award and the wager;
increasing the credit balance by the determined monetary award;
issuing value from a value dispenser based on the credit balance upon receipt of a cash out request.

20. A non-transitory computer-readable storage medium having machine instructions stored therein, the instructions being executable by a processor to cause the processor to:
establish a credit balance based at least in part on a monetary value received by a value acceptor;
issue a progressive non-monetary award upon an occurrence of a triggering condition in a play of a game;
place a wager following receipt of a wager input via an input device for a second play of the game, the credit balance being decreased by the wager;
activate a special game feature based on the progressive non-monetary award for the second play of the game;
execute the second play of the game based on the issued progressive non-monetary award and the wager;
determine a monetary award for the second play of the game based on the issued progressive non-monetary award and the wager;
increase the credit balance by the determined monetary award;
issue value from a value dispenser based on the credit balance upon receipt of a cash out request.
